(19) United States
(12) Patent Application Publication
(10) Pub. No.: US 2025/0212258 A1
(43) Pub. Date: Jun. 26, 2025

(54) SPATIAL FILTERING OF MULTIPLE RANDOM ACCESS CHANNEL TRANSMISSIONS

(71) Applicant: QUALCOMM Incorporated, San Diego, CA (US)

(72) Inventors: Hung Dinh Ly, San Diego, CA (US); Kexin Xiao, Shanghai (CN); Krishna Kiran Mukkavilli, San Diego, CA (US)

(21) Appl. No.: 18/846,384

(22) PCT Filed: Apr. 29, 2022
(86) PCT No.: PCT/CN2022/090547

§ 371 Date: Sep. 12, 2024

(51) Int. Cl. H04W 74/0833

(52) U.S. Cl. CPC H04W 74/0833

(57) ABSTRACT

In an aspect of the disclosure, a method, a computer-readable medium, and an apparatus are provided. The apparatus may be a user equipment (UE) or a component thereof. The apparatus may be configured to receive a random access channel (RACH) configuration for a RACH procedure with a network node. The apparatus may be further configured to determine a set of spatial domain filters for the RACH procedure based on the RACH configuration, and each respective spatial domain filter of the set of spatial domain filters corresponds to a respective reference signal of a set of reference signals. The apparatus may be further configured to perform the RACH procedure, and to perform the RACH procedure, the apparatus may be configured to transmit, to the network node, a plurality of preamble messages using the set of spatial domain filters based on the RACH configuration.

The present disclosure generally relates to communication systems, and more particularly, to applying spatial domain filtering to multiple transmissions of preamble messages for random access channel (RACH) procedures.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE) or a component thereof. The apparatus may be configured to receive a random access channel (RACH) configuration for a RACH procedure with a network node. The apparatus may be further configured to determine a set of spatial domain filters for the RACH procedure based on the RACH configuration, and each respective spatial domain filter of the set of spatial domain filters corresponds to a respective reference signal of a set of reference signals. The apparatus may be further configured to perform the RACH procedure, and to perform the RACH procedure, the apparatus may be configured to transmit, to the network node, a plurality of preamble messages using the set of spatial domain filters based on the RACH configuration.

In another aspect of the disclosure, another method, another computer-readable medium, and another apparatus are provided. The other apparatus may be a network node or a component thereof. The other apparatus may be configured to transmit each of a set of reference signals via a respective beam of a set of beams. The other apparatus may be further configured to transmit a RACH configuration associated with spatial domain filtering for transmission of a plurality of preamble messages of a RACH procedure. The other apparatus may be further configured to perform the RACH procedure, and to perform the RACH procedure, the other apparatus may be configured to perform the RACH procedure, wherein, to perform the RACH procedure, the at least one processor is configured to receive, from a UE, at least one of the plurality of preamble messages associated with at least one of a set of spatial domain filters that corresponds to at least one set of the set of beams.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink channels within a subframe, in accordance with various aspects of the present disclosure.

FIG. 3 is a diagram illustrating an example of a base station and user equipment (UE) in an access network.

FIG. 4 is a call flow diagram illustrating an example flow of operations for transmission of a plurality of random access channel (RACH) preamble messages using a set of spatial domain filters.

FIG. 5A is a block diagram illustrating an example of transmission of preamble messages by a UE to a base station for a RACH procedure.

FIG. 5B is a block diagram illustrating another example of transmission of preamble messages by a UE to a base station for a RACH procedure.

FIG. 6 is a flowchart illustrating an example of a method of wireless communication at a UE.

FIG. 7 is a flowchart illustrating an example of a method of wireless communication at a network node.

FIG. 8 is a diagram illustrating an example of a hardware implementation for an example apparatus.

FIG. 9 is a diagram illustrating another example of a hardware implementation for another example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, the concepts and related aspects described in the present disclosure may be implemented in the absence of some or all of such specific details. In some instances, well-known structures, components, and the like are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, computer-executable code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or computer-executable code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer-executable code in the form of instructions or data structures that can be accessed by a computer.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

According to various radio access technologies (RATs), a random access (RA) or RA channel (RACH) procedure may be performed, for example, in order for a UE to acquire uplink timing synchronization and/or an uplink grant with a network node, such as a base station, gNB, a radio unit, or another similar network entity. Different conditions may cause the UE to perform a RACH procedure with a network node. For example, a UE may perform a RACH procedure during initial access to a cell provided by a network node, handover to the cell, reacquisition of uplink timing synchronization, etc.

A RACH procedure may include the exchange of messages between a UE and a network node. For example, one type of RACH procedure may include the exchange of four messages between the UE and the network node, and may be referred to as a “four-step RACH procedure.” The present disclosure describes various concepts and aspects in the context of such a four-step RACH procedure; however, one of ordinary skill will appreciate that the various concepts and aspects described herein may be practiced with other random access or RACH procedures, including a “two-step” RACH procedure in which a MsgA is first transmitted by a UE and then a MsgB is transmitted by a network node in response. For example, the MsgA may incorporate some or all of the various concepts and aspects described herein with respect to a preamble message (also referred to as a “msg1”) and a connection request message (also referred to as a “msg3”), and the MsgB may incorporate some or all of the various concepts and aspects described herein with respect to a random access response (RAR) message (also referred to as a “msg2”) and a contention resolution message (also referred to as a “msg4”).

A four-step RACH procedure for initial access by a UE may begin with acquisition by the UE of at least one reference signal (e.g., SSB, another synchronization signal, another reference signal, etc.) and system information (e.g., at least one SIB, such as a SIB1). For example, a network node may broadcast each of the reference signals and SIBs in the coverage area of the network node, e.g., periodically on a known channel(s) so that the UE may acquire information to establish communication with the network node. In particular, the UE may obtain various parameters associated with initial access from the at least one SIB, and further, the UE may obtain information applicable to directional beamforming or resource selection from the at least one SSB.

Based on the initial access-associated parameters, the UE may transmit a preamble message to the network node, such as by selecting a RACH occasion and transmitting the preamble message in the selected RACH occasion. The preamble message may also be referred to as a “msg1” and/or a physical RACH (PRACH) message in the four-step RACH procedure. The UE may expect to receive a RAR message from the network node in response to the preamble message.

In particular, the UE may monitor for the RAR message in an RAR window. The duration of the RAR window may be configured for the UE through the initial access parameters. If the UE fails to receive the RAR message in the RAR window, the UE may retransmit the preamble message with a higher transmit power, e.g., according to a power ramping step indicated by the initial access parameters.

When the network node receives the preamble message, the network node may generate and respond with the RAR message. The RAR message may be also referred to as a “msg2” in the four-step RACH procedure. The RAR message may include control information and/or data, e.g., on a PDCCH and a PDSCH, respectively.

In some aspects, the RAR message may indicate a radio network temporary identifier (RNTI), such as a temporary cell (TC) RNTI and/or an RA-RNTI. The network node may scramble the control information on the PDCCH (e.g., DCI) with an RNTI, for example, based on the RACH occasion in which the UE transmitted the preamble message. With respect to the content of the PDSCH, the network node may include acknowledgement feedback in a MAC control element (CE) in order to acknowledge reception of the preamble message. In addition, the network node may include an uplink grant on the PDSCH of the RAR message.

In monitoring for the RAR message during the RAR window, the UE may monitor for DCI (e.g., DCI format 1_0) on the PDCCH that is scrambled with the RNTI corresponding to the RACH occasion in which the UE transmitted the preamble message. When the UE detects such DCI, the UE may detect and decode the associated content on the PDSCH. If the UE identifies the acknowledgement feedback in the MAC CE corresponding to the preamble message transmitted by the UE, the UE may determine that the uplink grant carried on the PDSCH is intended for the UE.

Based on the uplink grant, the UE may transmit a connection request message on a physical uplink shared channel (PUSCH). The connection request message may also be known as a “msg3” in the four-step RACH procedure. The UE may indicate an identifier (ID) of the UE in the connection request message. Further, the connection request message may indicate a radio resource control (RRC) connection request, a scheduling request, a buffer status request, and/or another request(s). The network node may receive the connection request message from the UE and may identify the UE from the ID indicated thereby. The network node may perform contention resolution based on the received connection request message.

Based on the result of the contention resolution, the network node may generate and send a contention resolution message to the UE. The contention resolution message may also be known as a “msg4” in the four-step RACH procedure. The UE may receive the contention resolution message and, as the four-step RACH procedure for cell access may be successfully completed (e.g., potentially after the UE transmits acknowledgement feedback to the network node based on the contention resolution message), may camp on the cell and/or communicate with the network node. Table 1 illustrates the physical (PHY) layer channels and contents of the four messages exchanged over a four-step RACH procedure.

TABLE 1

| Message | PHY Channel | Content |
|---|---|---|
| msg1 | PRACH | preamble |
| msg2 | PDCCH, PDSCH | Timing advance, uplink grant |
| | | for msg3, TC-RNTI, |
| | | etc. |
| msg3 | PUSCH | RRC connection request, |
| | | scheduling request, buffer |
| | | status, etc. |
| msg4 | PDCCH, PDSCH | Contention resolution message |

In some instances, however, the network node may fail to receive a RACH preamble message transmitted by a UE. Illustratively, a UE may be located near a cell edge, and so the preamble message may be more susceptible to interference and/or channel fading. In some other examples, the number and/or respective sizes of blockers or other channel occlusions may prevent the network node from successfully receiving and decoding a preamble message. In still other examples, a number of UEs attempting RACH procedures may overwhelm the resources available for RACH preamble transmission (e.g., RACH occasions).

In addition to the aforementioned potential failures of four-step RACH procedures, four-step RACH procedures may incur an appreciable amount of time and/or signaling overhead. For example, preamble message transmission and RAR message transmission may cause congestion and/or interference in millimeter wave (mmW) systems, such as in 5G New Radio (NR) mmW networks, which may adversely affect coverage. In view of the foregoing, a need exists for approaches to increase the coverage and reduce instances of preamble transmission failure that have the potential to occur during RACH procedures.

The present disclosure provides various techniques and solutions for coverage enhancements and reductions in preamble transmission failures in RACH procedures. Specifically, the present disclosure provides for multiple preamble message transmissions for a single RACH procedures, e.g., in which two or more of the aforementioned RACH preamble transmissions differ across one or more of the spatial domain, time domain, and/or frequency domain. In some aspects of the present disclosure, for example, RACH preamble transmission as described herein may increase coverage through PRACH repetition and/or using different spatial domain filtering to transmit two or more RACH messages. Such PRACH repetition and/or spatial domain filtering diversity may increase the opportunities for receiving RACH preamble messages at a network node, which may improve PRACH transmission coverage when the network node transmits RAR messages and/or other messages (e.g., contention resolution messages).

While the present disclosure describes various aspects and other concepts related to RACH procedures in terms of mmW and/or frequency range designation FR2 from 24.25 gigahertz (GHz) to 52.6 GHz, it will be appreciated that the various aspects and other concepts may be applicable to in other spectrums, such as sub-6 GHz, sub-7 GHz, and/or frequency range designation FR1 from 410 megahertz (MHz) to 7.125 GHz.

In addition, the various concepts and aspects described herein related to RACH preamble transmission may be agnostic to PUCCH format. In some aspects, a certain formats may be used for illustrative purposes, such as PRACH format B4 and/or other short PUCCH formats; however, the various concepts and aspects described herein may be applicable to additional or alternative PRACH and/or PUCCH formats without departing from the scope of the present disclosure.

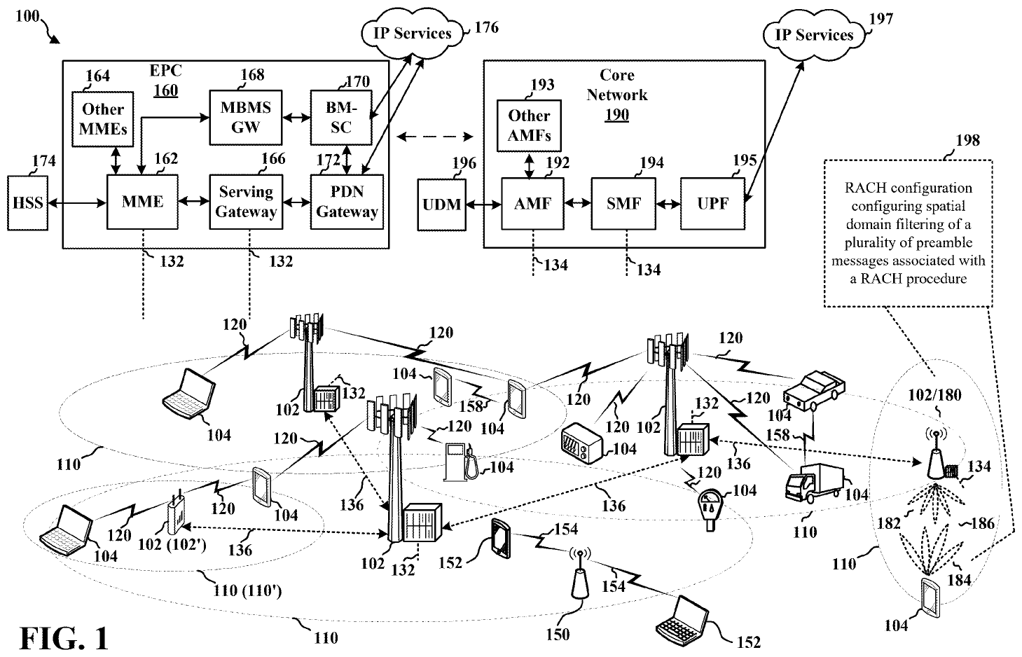

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular network node) and/or small cells (low power cellular network node). The macrocells include base stations, gNBs, or other similar network entities. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., SI interface). The base stations 102 configured for 5G NR, which may be collectively referred to as Next Generation radio access network (RAN) (NG-RAN), may interface with core network 190 through second backhaul links 134. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, Multimedia Broadcast Multicast Service (MBMS), subscriber and equipment trace, RAN information management (RIM), paging, positioning, and delivery of warning messages.

In some aspects, the base stations 102 may communicate directly or indirectly (e.g., through the EPC 160 or core network 190) with each other over third backhaul links 136 (e.g., X2 interface). The first backhaul links 132, the second backhaul links 134, and the third backhaul links 136 may be wired, wireless, or some combination thereof. At least some of the base stations 102 may be configured for IAB. Accordingly, such base stations may wirelessly communicate with other base stations, which also may be configured for IAB.

At least some of the base stations 102 configured for IAB may have a split architecture that includes at least one of a CU), a DU, an RU, a remote radio head (RRH), and/or a radio unit, some or all of which may be collocated or distributed and/or may communicate with one another. In some configurations of such a split architecture, a CU may implement some or all functionality of an RRC layer, whereas a DU may implement some or all of the functionality of a radio link control (RLC) layer.

Illustratively, some of the base stations 102 configured for IAB may communicate through a respective CU with a DU of an IAB donor node or other parent IAB node (e.g., a base station, network node, etc.), and further, may communicate through a respective DU with child IAB nodes (e.g., another base stations, another network node, etc.) and/or one or more of the UEs 104. One or more of the base stations 102 configured for IAB may be an IAB donor connected through a CU with at least one of the EPC 160 and/or the core network 190. With such a connection to the EPC 160 and/or core network 190, a base station 102 operating as an IAB donor may provide a link to the EPC 160 and/or core network 190 for one or more UEs and/or other IAB nodes, which may be directly or indirectly connected (e.g., separated from an IAB donor by more than one hop) with the IAB donor. In the context of communicating with the EPC 160 or the core network 190, both the UEs and IAB nodes may communicate with a DU of an IAB donor. In some additional aspects, one or more of the base stations 102 may be configured with connectivity in an open RAN (ORAN) and/or a virtualized RAN (VRAN), which may be enabled through at least one respective CU, DU, RU, RRH, and/or remote unit.

The base stations 102 may wirelessly communicate with the UEs 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Each of the base stations 102 may provide communication coverage for a respective geographic coverage area 110, which may also be referred to as a “cell.” Potentially, two or more geographic coverage areas 110 may at least partially overlap with one another, or one of the geographic coverage areas 110 may contain another of the geographic coverage areas. For example, the small cell 102′ may have a coverage area 110′ that overlaps with the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use multiple-input and multiple-output (MIMO) antenna technology, including spatial multiplexing, beamforming, and/or transmit diversity. Wireless links or radio links may be on one or more carriers, or component carriers (CCs). The base stations 102 and/or UEs 104 may use spectrum up to Y MHz (e.g., Y may be equal to or approximately equal to 5, 10, 15, 20, 100, 400, etc.) bandwidth per carrier allocated in a carrier aggregation of up to a total of Yx MHz (e.g., x CCs) used for transmission in each direction. The CCs may or may not be adjacent to each other. Allocation of CCs may be asymmetric with respect to downlink and uplink (e.g., more or fewer CCs may be allocated for downlink than for uplink).

The CCs may include a primary CC and one or more secondary CCs. A primary CC may be referred to as a primary cell (PCell) and each secondary CC may be referred to as a secondary cell (SCell). The PCell may also be referred to as a “serving cell” when the UE is known both to a base station at the access network level and to at least one core network entity (e.g., AMF and/or MME) at the core network level, and the UE may be configured to receive downlink control information in the access network (e.g., the UE may be in an RRC Connected state). In some instances in which carrier aggregation is configured for the UE, each of the PCell and the one or more SCells may be a serving cell.

Certain UEs 104 may communicate with each other using device-to-device (D2D) communication link 158. The D2D communication link 158 may use the downlink/uplink WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (or “mmWave” or simply “mmW”) band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, the term “sub-6 GHZ,” “sub-7 GHZ,” and the like, to the extent used herein, may broadly represent frequencies that may be less than 6 GHz, frequencies that may be less than 7 GHz, frequencies that may be within FR1, and/or frequencies that may include mid-band frequencies. Further, unless specifically stated otherwise, the term “millimeter wave” and other similar references, to the extent used herein, may broadly represent frequencies that may include mid-band frequencies, frequencies that may be within FR2, and/or frequencies that may be within the EHF band.

A base station 102 or network node, whether a small cell 102′ or a large cell (e.g., macro base station), may include and/or be referred to as an eNB, gNodeB (gNB), or another type of base station or network entity. Some base stations 180, such as gNBs, may operate in a traditional sub 6 GHz spectrum, in mmW frequencies, and/or near-mmW frequencies in communication with the UE 104. When such a base station 180 (e.g., gNB) operates in mmW or near-mmW frequencies, the base station 180 may be referred to as a mmW base station (or mmW network node, in some aspects). The (mmW) base station 180 may utilize beamforming 186 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182. The UE 104 may receive the beamformed signal from the base station 180 in one or more receive directions 184. The UE 104 may also transmit a beamformed signal to the base station 180 in one or more transmit directions. The base station 180 may receive the beamformed signal from the UE 104 in one or more receive directions. One or both of the base station 180 and/or the UE 104 may perform beam training to determine the best receive and/or transmit directions for the one or both of the base station 180 and/or UE 104. The transmit and receive directions for the base station 180 may or may not be the same. The transmit and receive directions for the UE 104 may or may not be the same.

In various different aspects, one or more of the base stations 102/180 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology.

In some aspects, one or more of the base stations 102/180 may be connected to the EPC 160 and may provide respective access points to the EPC 160 for one or more of the UEs 104. The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, with the Serving Gateway 166 being connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a Packet Switch (PS) Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

In some other aspects, one or more of the base stations 102/180 may be connected to the core network 190 and may provide respective access points to the core network 190 for one or more of the UEs 104. The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QOS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a PS Streaming Service, and/or other IP services.

In certain aspects, the UE 104 may be configured to transmit multiple preamble messages to the base station 102/180, e.g., for a single RACH procedure. That is, the UE 104 may transmit two or more preamble messages, which may be multiplexed in time and/or frequency, without waiting for an RAR message from the base station 102/180 responsive to at least one of the preamble messages.

The base station 102/180 may configure the UE 104 with a RACH configuration that indicates a number K of preamble transmissions that the UE 104 is to attempt. The number K of preamble transmissions may be greater than one—e.g., K may be equal to two (2), four (4), six (6), eight (8), or another integer. The base station 102/180 may configure the UE 104 with the number K of preamble transmissions via system information, such as a system information block (SIB) that is broadcast in a cell provided by the base station 102/180, and/or via RRC signaling (e.g., unicast message transmitted to the UE 104).

In some aspects, the base station 102/180 may configure a number of spatial domain filters with which the UE 104 is to transmit the preamble transmissions. For example, the base station 102/180 may transmit information indicating that each of the K preamble transmissions is to be transmitted using a spatial domain filter that is different from other spatial domain filters used to transmit other preamble transmissions (that is, the UE 104 may transmit each preamble transmission using a unique spatial domain filter). In another example, the base station 102/180 may transmit information indicating that at least one spatial domain filter is to be used to transmit at least two preamble transmissions (e.g., the UE 104 may multiplex at least two preamble transmissions in the time domain and the spatial domain, and not in the frequency domain).

Thus, as described herein, the base station 102/180 may transmit a RACH configuration configuring spatial domain filtering of a plurality of preamble messages associated with a RACH procedure (198). The base station 102/180 may further receive, from the UE 104 for the RACH procedure, at least one of the plurality of preamble messages for the RACH procedure, with the plurality of preamble messages being associated with a set of spatial domain filters that respectively correspond to a set of reference signals transmitted by the base station 102/180.

Correspondingly, the UE 104 may be configured to receive the RACH configuration configuring spatial domain filtering of a plurality of preamble messages associated with a RACH procedure (198). The UE 104 may be further configured to select a set of spatial domain filters for the RACH procedure based on the RACH configuration, with each of the set of spatial domain filters corresponding to a respective one of a set of reference signals received from a base station 102/180. The UE 104 may be further configured to transmit, to the base station 102/180, a plurality of preamble messages for the RACH procedure using the set of spatial domain filters.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

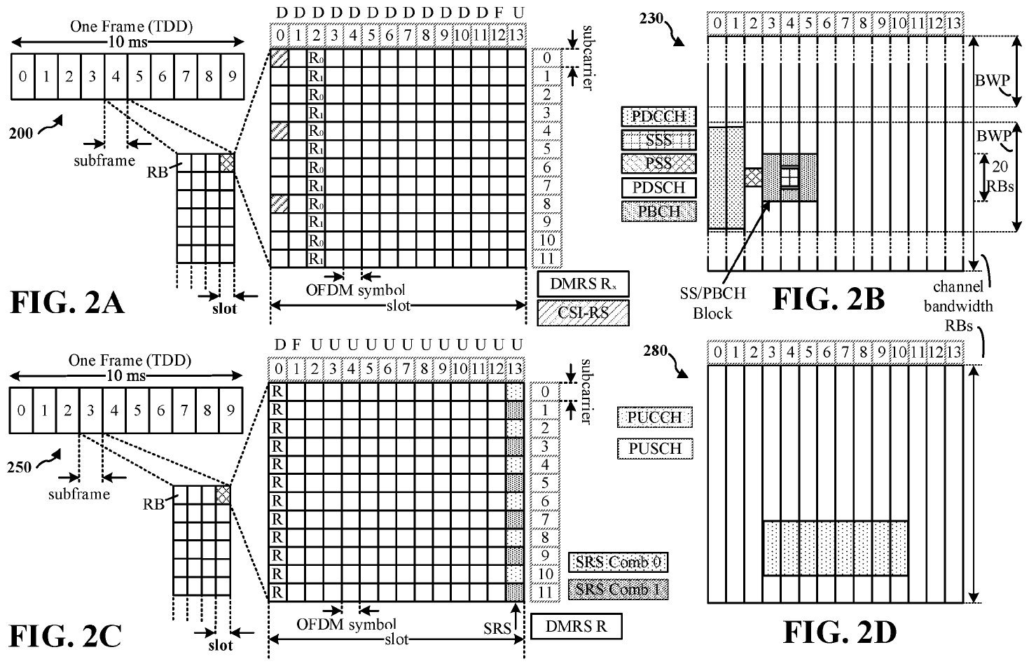

FIG. 2A is a diagram illustrating an example of a first subframe 200 within a 5G NR frame structure. FIG. 2B is a diagram illustrating an example of downlink channels within a 5G NR subframe 230. FIG. 2C is a diagram illustrating an example of a second subframe 250 within a 5G NR frame structure. FIG. 2D is a diagram illustrating an example of uplink channels within a 5G NR subframe 280. The 5G NR frame structure may be frequency division duplexed (FDD) in which for a particular set of subcarriers (carrier system bandwidth), subframes within the set of subcarriers are dedicated for either downlink or uplink, or may be time division duplexed (TDD) in which for a particular set of subcarriers (carrier system bandwidth), subframes within the set of subcarriers are dedicated for both downlink and uplink. In the examples provided by FIGS. 2A, 2C, the 5G NR frame structure is assumed to be TDD, with subframe 4 being configured with slot format 28 (with mostly downlink), where D is downlink, U is uplink, and F is flexible for use between downlink/uplink, and subframe 3 being configured with slot format 34 (with mostly uplink). While subframes 3, 4 are shown with slot formats 34, 28, respectively, any particular subframe may be configured with any of the various available slot formats 0-61. Slot formats 0, 1 are all downlink, uplink, respectively. Other slot formats 2-61 include a mix of downlink, uplink, and flexible symbols. UEs are configured with the slot format (dynamically through downlink control information (DCI), or semi-statically/statically through RRC signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on downlink may be cyclic prefix (CP) orthogonal frequency-division multiplexing (OFDM) (CP-OFDM) symbols. The symbols on uplink may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 microseconds (μs). Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry at least one pilot signal, such as a reference signal (RS), for the UE. Broadly, RSs may be used for beam training and management, tracking and positioning, channel estimation, and/or other such purposes. In some configurations, an RS may include at least one demodulation RS (DM-RS) (indicated as Rx for one particular configuration, where 100× is the port number, but other DM-RS configurations are possible) and/or at least one channel state information (CSI) RS (CSI-RS) for channel estimation at the UE. In some other configurations, an RS may additionally or alternatively include at least one beam measurement (or management) RS (BRS), at least one beam refinement RS (BRRS), and/or at least one phase tracking RS (PT-RS).

FIG. 2B illustrates an example of various downlink channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as SIBs, and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the PUSCH. The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the uplink.

FIG. 2D illustrates an example of various uplink channels within a subframe of a frame. The PUCCH may be located as indicated in one configuration. The PUCCH carries uplink control information (UCI), which may include a scheduling request (SR), a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

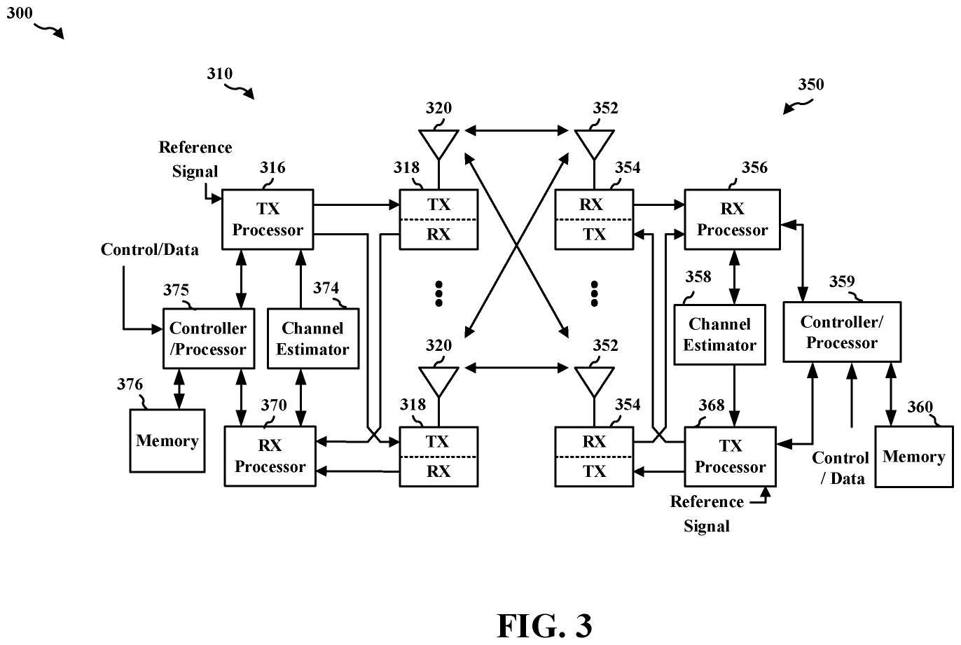

FIG. 3 is a block diagram of a base station 310 in communication with a UE 350 in an access network 300. In the downlink, IP packets from the EPC 160 may be provided to a controller/processor 375. The controller/processor 375 implements Layer 2 (L2) and Layer 3 (L3) functionality. L3 includes an RRC layer, and L2 includes a service data adaptation protocol (SDAP) layer, a packet data convergence protocol (PDCP) layer, an RLC layer, and a medium access control (MAC) layer.

The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement Layer 1 (L1) functionality associated with various signal processing functions. L1, which includes a PHY layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate a radio frequency (RF) carrier with a respective spatial stream for transmission.

At the UE 350, each receiver 354RX receives a signal through at least one respective antenna 352. Each receiver 354RX recovers information modulated onto an RF carrier and provides the information to the receive (RX) processor 356. The TX processor 368 and the RX processor 356 implement L1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements L3 and L2 functionality.

The controller/processor 359 can be associated with a memory 360 that stores program codes and data. The memory 360 may be referred to as a computer-readable medium. In the uplink, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the downlink transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The uplink transmission is processed at the base station 310 in a manner similar to that described in connection with the receiver function at the UE 350. Each receiver 318RX receives a signal through at least one respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the uplink, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some aspects, at least one of the TX processor 368, the RX processor 356, and the controller/processor 359 may be configured to perform aspects in connection with the RACH configuration configuring spatial domain filtering of a plurality of preamble messages associated with a RACH procedure (198) of FIG. 1.

In some other aspects, at least one of the TX processor 316, the RX processor 370, and the controller/processor 375 may be configured to perform aspects in connection with the RACH configuration configuring spatial domain filtering of a plurality of preamble messages associated with a RACH procedure (198) of FIG. 1.

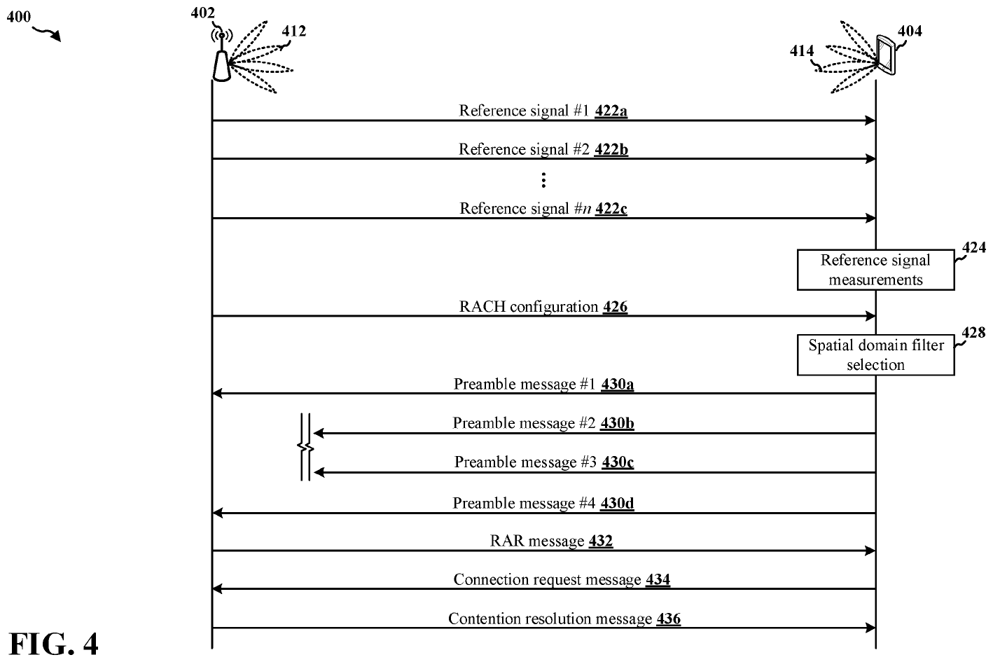

FIG. 4 is a call flow diagram illustrating an example flow of operations 400 for transmission of a plurality of RACH preamble messages 430a-430d using a set of spatial domain filters. At least one of the base station 402 and/or the UE 404 may implement beamforming, which may include the radiation and/or reception of energy. In some aspects, a spatial domain filter may refer to a beam or energy radiated or received in a certain direction. To that end, reference to using a spatial domain filter may be substantially similar to equivalent to generating a beam or activating a beam. Thus, spatial domain filtering may be regarded as functionally equivalent to beamforming for the purposes of the present disclosure.

A spatial domain filter may be implemented via one or more integrated circuits (ICs), chips, processors, and/or other circuitry configured to apply a function (e.g., a mapping, a transformation, etc.) to transmit and/or receive signals via a directional beam, with the function defining the characteristics of a beam (e.g., beam direction, beam shape, beam power, and/or other characteristics) through which such signals are transmitted and/or received. For example, the function may be used to determine the number of antennas and/or antenna elements, the structure of the antenna elements, weights of antenna elements, and so forth. In the context of signal transmission, spatial domain filtering may include a function that adjusts the phase and/or amplitude applied to signals transmitted at antenna elements. In the context of signal reception, spatial domain filtering may include a function that separates signals having overlapping frequency content but originating from different spatial locations. Such a function may be implemented in hardware, software, firmware, or any combination thereof.

The base station 402 may provide a cell (e.g., coverage area 110 of FIG. 1), which the UE 404 may enter. In the cell, the base station 402 may broadcast each of a set of reference signals 422a-422c on a respective one of a set of beams 412. Thus, each of the reference signals 422a-422c may be transmitted via a corresponding one of the base station beams 412. In some aspects, at least one of the reference signals 422a-422c may be or may include an SSB. For example, the reference signals 422a-422c may be or may include SSBs when the UE 404 is performing a RACH procedure for initial access or when the UE 404 is operating in a connected state. In some other aspects, at least one of the reference signals 422a-422c may be or may include a CSI-RS. In still other aspects, a first subset of the reference signals 422a-422c may be or may include a set of SSBs, and a second subset of the reference signals 422a-422c may be or may include a set of CSI-RSs. For example, some or all of the reference signals 422a-422c may be or may include at least one CSI-RS when the UE 404 is operating in a connected state (e.g., RRC_Connected state, such as for beam recovery or for on-demand system information).

The UE 404 may receive, via at least one of UE beams 414, each of the reference signals 422a-422c transmitted via a corresponding one of the base station beams 412. Each of the UE beams 414 may be generated using a respective spatial domain filter—e.g., each of a set of spatial domain filters at the UE 404 may be used to radiate or detect energy in a direction corresponding to a respective one of the UE beams 414.

The UE 404 may identify a respective beam of the base station beams 412 based on receiving a corresponding one of the reference signals 422a-422c that is transmitted via the respective beam. That is, each of the reference signals 422a-422c may indicate information that uniquely identifies a respective one of the base station beams 412 so that the corresponding reference signal serves to identify the respective beam via which the corresponding reference signal was transmitted. For example, the first reference signal 422a may uniquely identify a first beam of the base station beams 412 (e.g., via a first index), the second reference signal 422b may uniquely identify a second beam of the base station beams 412 (e.g., via a second index), and so forth.

In receiving each of the reference signals 422a-422c, the UE 404 may determine (e.g., calculate, compute, etc.) measurement information 424, which may include measuring the signal strength or quality with which each of the reference signals 422a-422c is received when transmitted via a respective one of the base station beams 412 and received via a respective one of the UE beams 414. For example, the UE 404 may determine (e.g., measure), for the measurement information 424, a reference signal receive power (RSRP), a reference signal receive quality (RSRQ), a signal-to-noise ratio (SNR), a signal-to-interference-plus-noise ratio (SINR), and/or a reference signal strength indicator (RSSI) respectively corresponding to each of the reference signals 422a-422c received by the UE 404.

One of the UE beams 414 may be paired with one of the base station beams 412 based on receiving a respective one of the reference signals 422a-422c. For example, the UE 404 may pair one of the UE beams 414 (identified via an index at the UE 404) with one of the base station beams 412 on which the first reference signal 422a is transmitted based on the one of the UE beams 414 used to receive the first reference signal 422a with the highest or “best” signal power, quality, or other measurement (e.g., highest or best RSRP, RSRQ, SNR, SINR, etc.). Effectively, the UE 404 may store information indicating an index of a spatial domain filter paired with a first index of one of the base station beams 412 based on receiving the first reference signal 422a with a highest or “best” measurement via that spatial domain filter.

The UE 404 may then use the same or similar spatial domain filter via which the first reference signal 422a was received to transmit and/or receive signals to the base station 402 via the corresponding one of the base station beams 412. For example, the UE 404 may apply a spatial domain filter having the same or similar characteristics to that used to receive the first reference signal 422a in order to form a beam for transmitting a signal on a first beam of the base station beams 412.

Further, the base station 402 may transmit (e.g., broadcast), and the UE 404 may receive, the RACH configuration 426. In some aspects, the RACH configuration 426 may be included in one or more SIBs, such as a SIB1. In some other aspects, the RACH configuration 426 may be included in remaining minimum system information (RMSI) and/or other system information (OSI)—e.g., a SIB1 may carry some or all RMSI, and one or more of SIB2 through SIB9 may carry some or all OSI. In still other aspects, the RACH configuration 426 may be included in one or more RRC signaling messages, which may be unicast by the base station 402 to the UE 404.

The RACH configuration 426 may include initial access parameters and, in particular, parameters for a RACH procedure, such as a two-step RACH procedure and/or a four-step RACH procedure. In some aspects, the RACH configuration 426 may include information associated with a set of spatial domain filters that may be used for transmission of RACH preamble messages. For example, the RACH configuration 426 may configure a number of spatial domain filters the UE 404 is to use for transmission of preamble messages and/or a number of the preamble messages that the UE 404 is to transmit for a RACH procedure. Further, the RACH configuration 426 may indicate whether the UE 404 is to use the same preamble across all preamble messages for a RACH procedure or the UE 404 is to use at least two different preambles across the preamble messages for the RACH procedure.

In other words, the RACH configuration 426 may configure the UE 404 with a number of preamble messages that are to be transmitted, and whether those preamble messages are to be transmitted with the same spatial domain filter associated with the same reference signal (e.g., SSB or CSI-RS having the strongest received power) or different spatial domain filters associated with different reference signals. Further, the RACH configuration 426 may configure the UE 404 to transmit repetitions of a preamble message (i.e., each preamble message includes the same preamble) or may configure the UE 404 to transmit different preamble messages, all of which may still convey information identifying the UE 404 for a RACH procedure.

In some aspects, the RACH configuration 426 may include a set of criteria according to which the UE 404 is to select spatial domain filters. For example, the RACH configuration 426 may include at least one threshold (e.g., labeled “rsrp-ThresholdSSB” or similar for SSBs and/or labeled “rsrp-ThresholdCSI-RS” or similar for CSI-RSs) that is to be satisfied (e.g., met or exceeded) by a signal strength measured from a reference signal corresponding to a spatial domain filter in order for that spatial domain filter to be used for transmission of a RACH preamble message. In other words, the UE 404 may use a spatial domain filter for transmission of a preamble message if the reference signal corresponding to that spatial domain filter is received with a measurable signal strength that satisfies (e.g., is greater than or equal to) the at least one threshold. In some other aspects, the RACH configuration 426 may include multiple thresholds.

According to various aspects, the UE 404 may perform a RACH procedure for network communication with the base station 402. For example, the UE 404 may be in an RRC state other than RRC_Connected, such as a disconnected state or an idle state. The UE 404 may perform a RACH procedure to establish a connection with the base station 402, for example, when initially accessing the cell provided by the base station 402, obtaining uplink synchronization with the base station 402, obtaining an uplink grant from the base station 402, etc. In some other examples, the UE 404 may perform a RACH procedure in order to communicate or maintain a connection with the base station 402, such as when the UE 404 is operating in an RRC_Connected state and requests on-demand system information or performs beam failure recovery in response to radio link failure. In one aspect, the UE 404 may perform a four-step RACH procedure. In another aspect, the UE 404 may perform a two-step RACH procedure.

In order to perform the RACH procedure, the UE 404 may select a set of spatial domain filters for the RACH procedure based on the RACH configuration 426. The set of spatial domain filters may be used to transmit a set of RACH preamble messages for the RACH procedure. Each of the spatial domain filters may correspond to a respective one of the set of reference signals 422a-422c received from the base station 402. For example, a first spatial domain filter may be used to form a first one of the UE beams 414 that is paired with a first one of the base station beams 412 via which the first reference signal 422a was transmitted; thus, the first spatial domain filter may correspond to the first reference signal 422a, the first beam of the UE beams 414, the first beam of the base station beams 412, and/or a first beam pair of the first beams of the UE beams 414 and the base station beams 412.

The UE 404 may be configured to transmit multiple preamble messages 430a-430d for a single RACH procedure, or for multiple contemporaneous RACH procedures, etc. The UE 404 may generate a preamble, e.g., based on information included in the RACH configuration 426. For example, the UE 404 may generate a preamble sequence from a set of available preamble sequences based on the RACH configuration 426.

In some aspects, the UE 404 may generate one preamble, and each of the multiple preamble messages 430a-430d may include the same preamble. In some other aspects, the UE 404 may generate multiple preambles, and each of the multiple preamble messages 430a-430d may include a respective different one of the multiple preambles. Each of the preamble messages 430a-430d may identify the UE 404 to the base station 402 for a RACH procedure.

The UE 404 may transmit each of the preamble messages 430a-430d via a respective spatial domain filter of the set of spatial domain filters. The UE 404 may select a number of the set of spatial domain filters, e.g., based on the RACH configuration 426. In some aspects, the UE 404 may transmit each of the multiple preamble messages 430a-430d via a respectively different one of the set of spatial domain filters. In some other aspects, the UE 404 may transmit each of the multiple preamble messages 430a-430d via the same spatial domain filter of the set of spatial domain filters.

For example, the UE 404 may compare the measurement information 424 (e.g., the RSRP, SNR, SINR, etc.) for at least one of the reference signals 422a-422c to a threshold, such as a preconfigured threshold or a threshold indicated in the RACH configuration 426. If the UE 404 determines that the measurement information 424 satisfies (e.g., meets or exceeds) the threshold, then the UE 404 may determine that the UE 404 is to transmit at least one of the preamble messages 430a-430d on the corresponding beam via which that one of the reference signals 422a-422c was received. Accordingly, the UE 404 may select 428 a spatial domain filter for the corresponding beam via which the one of the reference signals 422a-422c was received, and the UE 404 may transmit at least one of the preamble messages using the selected spatial domain filter. Where the UE 404 transmits preamble messages using more than one spatial domain filter, the UE 404 may transmit the preamble messages beginning with the spatial domain filter corresponding to the highest measured signal strength, and descending to the lowest measured signal strength.

Potentially, the number of signal strength measurements that satisfy a threshold for preamble transmission may be less than the number of preamble messages that the UE 404 is configured to transmit. In some aspects, if the number of signal strength measurements (measured from the reference signals 422a-422c) that satisfy the preamble transmission threshold is less than the number of preamble messages that the UE 404 is configured to transmit, then the UE 404 may transmit preamble messages in sequential order of the indices respectively corresponding to the configured spatial domain filters. In one example, the UE 404 may transmit preamble messages in ascending order (i.e., from lowest index to highest index). In another example, the UE 404 may transmit preamble messages in descending order (i.e., from highest index to lowest index). Whether the order is ascending or descending may be configured for the UE 404, e.g., via the RACH configuration 426.

In some other aspects, the RACH configuration 426 may include multiple thresholds. For example, each of the multiple thresholds may be associated with a respective spatial domain filter. A threshold may be associated with one or more spatial domain filters. The UE 404 may compare a signal strength measured from receiving a reference signal from the base station 402 to one or more of the multiple thresholds. If the UE 404 determines that the signal strength satisfies (e.g., meets or exceeds) at least one of the multiple thresholds, then the UE 404 may use a spatial domain filter corresponding to the received reference signal for transmitting at least one of the multiple RACH preamble messages. Accordingly, the UE 404 may select 428 multiple spatial domain filters for the corresponding beams via which the ones of the reference signals 422a-422c were received, and the UE 404 may transmit at least one of the preamble messages using the selected spatial domain filters.

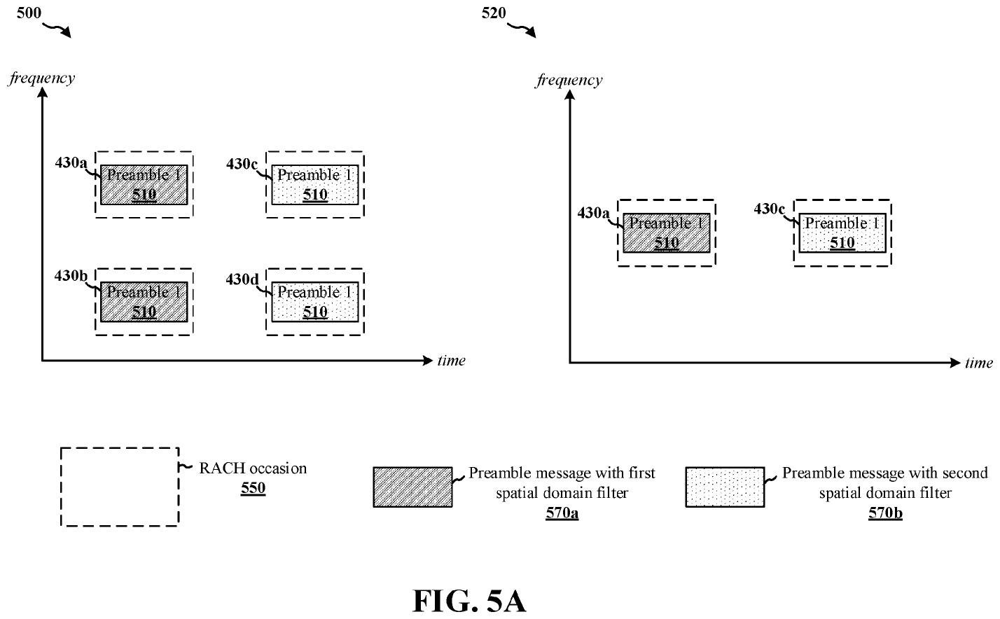

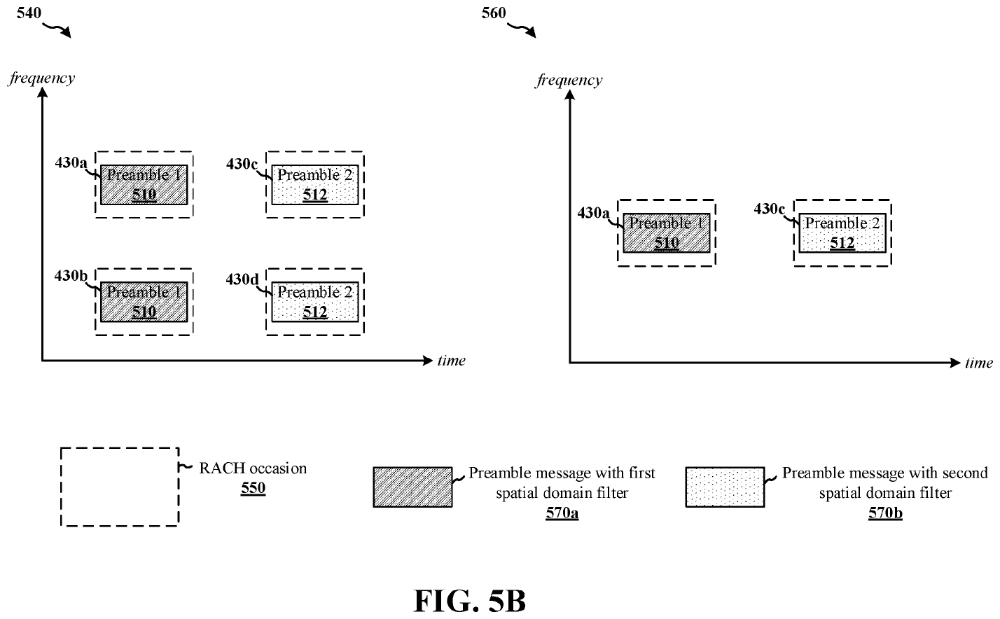

Referring now to FIGS. 5A and 5B, block diagrams illustrate examples of preamble transmissions 500, 520, 540, 560 by the UE 404 to the base station 402 for a RACH procedure. The illustrated preamble transmissions 500, 520, 540, 560 are to be regarded as illustrative and non-limiting. Thus, other preamble transmissions may be implemented without departing from the scope of the present disclosure.

A RACH occasion 550 may include a set of time and frequency resources on which a UE is permitted to transmit a preamble to a base station and, complementarily, a base station is to detect for preambles from UEs. A RACH occasion 550 may occur periodically in the time domain and, in some aspects, on one or more set(s) of frequency resources during each periodic set of time resources. FIGS. 5A and 5B show examples of different RACH occasions relative to preamble messages and spatial domain filters.

In some examples of preamble transmission 500, 540, the UE 404 may be configured to transmit four (4) RACH preamble messages over four (4) different RACH occasions 550. The UE 404 may be configured to transmit two (2) RACH preamble messages 430a, 430b using a first spatial domain filter 570a on a first set of time resources of the RACH occasions 550. However, the preamble messages 430a, 430b transmitted using the first spatial domain filter 570a and occupying the first set of time resources may be multiplexed in the frequency domain so that the respective sets of frequency resources carrying the preamble messages 430a, 430b do not overlap in the frequency domain. Thus, the preamble messages 430a, 430b may be differentiable and successfully receivable based upon the separation between the two in the frequency domain (e.g., in spite of the overlap between the two preamble messages 430a, 430b in the time and spatial domains).

Similarly, the UE 404 may be configured to transmit two (2) RACH preamble messages 430c, 430d using a second spatial domain filter 570b on a second set of time resources of the RACH occasions 550. The preamble messages 430c, 430d transmitted using the second spatial domain filter 570b and occupying the second set of time resources may be multiplexed in the frequency domain so that the respective sets of frequency resources carrying the preamble messages 430c, 430d do not overlap in the frequency domain. Thus, the preamble messages 430c, 430d may be differentiable and successfully receivable based upon the separation between the two preamble messages 430c, 430d in the frequency domain.

While a first one of the preamble messages 430a transmitted using the first spatial domain filter 570a may overlap in the frequency domain with a third one of the preamble messages 430c transmitted using the second spatial domain filter 570b, the first and third preamble messages 430a, 430c may be multiplexed in the time domain and the spatial domain. Similarly, the second and the fourth preamble messages 430b, 430d may be multiplexed in the time domain and the spatial domain, but may overlap in the frequency domain. Therefore, the preamble messages 430a, 430b transmitted using the first spatial domain filter 570a may be respectively differentiable from the preamble messages 430c, 430d transmitted using the second spatial domain filter 570b, and at least one of the first preamble messages 430a, 430b may be successfully decoded even when at least one of the second preamble messages 430c, 430d is received based upon the separation between each pair of preamble messages in the time domain and the spatial domain (in spite of the overlap between each respective pair in the frequency domain).

While the illustrated aspect shows the UE 404 transmitting four (4) RACH preamble messages, the UE 404 may be configured to transmit more or fewer than four preamble messages. Further, in various other aspects, the UE 404 may be configured to multiplex some or all of the multiple preamble transmissions in the time domain and/or the spatial domain, for example, in addition or alternative to the frequency domain. Accordingly, some other or none of the multiple preamble transmissions may overlap in the time domain and/or the spatial domain, for example, in alternative or addition to the frequency domain.

In some other aspects of preamble transmissions 520, 560, preamble messages may be transmitted in different RACH occasions 550 that do not overlap in time. For example, the UE 404 may be configured to transmit two (2) RACH preamble messages over two RACH occasions 550 that do no overlap in time. The UE 404 may be configured to transmit one (1) RACH preamble message 430a using a first spatial domain filter 570a on a first set of time resources of a RACH occasion 550. Further, the UE 404 may be configured to transmit one (1) other RACH preamble message 430c using a second spatial domain filter 570b on a second set of time resources of another RACH occasion 550.

In the example preamble transmissions 520, 560 in which preamble messages are transmitted at non-overlapping times, one preamble message 430a may overlap in the frequency domain with another preamble messages 430c. However, the preamble messages 430a, 430c may be multiplexed in the spatial domain because different spatial domain filters may be used to transmit the two preamble messages 430a, 430c. Further, as the one preamble message 430a and the other preamble message 430c may be transmitted in RACH occasions that do not overlap in time, the preamble messages 430a, 430c may be multiplexed in the time domain.

In some example preamble transmissions 500, 520, the preamble sequences included in each of the preamble messages 430a-430d may be the same preamble sequence. For example, each of the preamble messages 430a-430d may include preamble 1 510. While preamble messages have the same preamble when transmitted in RACH occasions that overlap in time, the same preamble may be included in other preamble messages transmitted in other RACH occasions that do not overlap in time. Thus, each of the preambles messages 430a-430d may include a repetition of the same preamble and may be an instance of the same preamble message.

In some other example preamble transmissions 540, 560, preamble sequences may be the same across preamble messages transmitted in RACH occasions that overlap in time, whereas preamble sequences may be different across preamble messages transmitted in RACH occasions that do not overlap in time. For example, the preamble message(s) 430a, 430b transmitted using the first spatial domain filter 570a in RACH occasions 550 overlapping at a first time may include a preamble 1 510. However, other preamble message(s) 430c, 430d transmitted using the second spatial domain filter 570b in other RACH occasions 550 that do not overlap with the first time may include a preamble 2 512 that is different from the preamble 1 510. Thus, while preamble messages transmitted in RACH occasions overlapping in time may have the same preamble, preamble messages in other RACH occasions that do not overlap in time may have different preambles, and so may not be repetitions of the same preamble message.

Returning to FIG. 4, not all of the RACH preamble messages 430a-430d may be received and successfully decoded by the base station 402, for example, due to path loss, interference, and/or another obstructing or attenuating factors. By way of illustration, the second and third preamble messages 430b, 430c may not reach the base station 402, such as when the UE 404 is proximate to a cell edge and/or signals from the UE 404 suffer an appreciable amount of interference while being detected at the antenna (a) of the base station 402. However, as the UE 404 may be configured to transmit multiple preamble messages to the base station 402, the probability that the base station 402 successfully receives and decodes at least one of the preamble messages 430a-430d is increased.

For example, the base station 402 may successfully receive and decode the first and fourth preamble messages 430a, 430d. The base station 402 may determine that the two preamble messages 430a, 430d are from the same UE 404 attempting a RACH procedure, and therefore, the base station 402 may drop or discard one of the preamble messages (e.g., the fourth preamble message 430d) and continue with the first preamble message 430a). Thus, based on the first preamble message 430a, the base station 402 may identify the UE 404 and proceed with the RACH procedure with the UE 404.

In some aspects, the base station 402 may transmit a RAR message 432 to the UE 404 in response to the received preamble message(s) (e.g., the first preamble message 430a). In instances in which the UE 404 and the base station 402 perform a four-step RACH procedure, the UE 404 may receive the RAR message 432 from the base station 402, and the UE 404 may transmit a connection request message 434 to the base station 402 based on the RAR message 432. When the base station 402 receives the connection request message 434, the base station 402 may transmit and a contention resolution message 436 to the UE 404. The RACH procedure may be complete after successful reception and acknowledgement of the contention resolution message 436 by the UE 404.

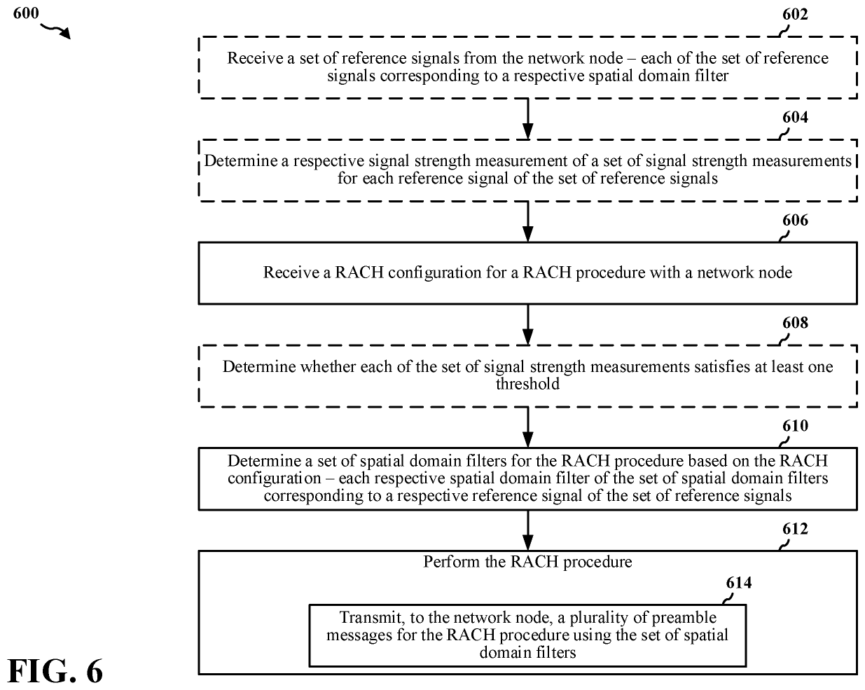

FIG. 6 is a flowchart 600 of a method of wireless communication. The method may be performed by or at a UE (e.g., the UE 104, 350, 404), another wireless communications apparatus (e.g., the apparatus 802), or one or more components thereof. According to various different aspects, one or more of the illustrated blocks may be omitted, transposed, and/or contemporaneously performed.

At 602, the UE may be configured to receive a set of reference signals from a network node. In some aspects, each of the set of reference signals may correspond to a respective spatial domain filter. In some aspects, the set of reference signals received from the network node may include a set of SSBs. In some other aspects, the set of reference signals received from the network node may include a set of CSI-RSs. In still other aspects, the set of reference signals received from the network node may include one subset of SSBs and another subset of CSI-RSs.

In the context of FIG. 4, for example, the UE 404 may receive the reference signals 422a-422c from the base station 402.

At 604, the UE may determine a respective signal strength measurement of a set of signal strength measurements for each reference signal of the set of reference signals. For example, the UE may detect energy on a set of resources carrying each reference signal, and the UE may measure the energy that corresponds to the reference signal. Each of the set of signal strength measurements may be or may include an RSRP (e.g., L1-RSRP), SNR (e.g., L1-SNR), RSRQ, SINR, RSSI, and/or another similar measurement indicative of channel quality and/or energy detected on channel resources.

In the context of FIG. 4, for example, the UE 404 may determine (e.g., measure, calculate, detect, etc.) measurement information 424. The measurement information 424 may include one or more measurements indicative of a respective quality and/or power associated with one or more of the base station beams 412 via which one or more of the reference signals 422a-422c were respectively transmitted and/or one or more of the UE beams 414 via which one or more of the reference signals 422a-422c are respectively received.

At 606, the UE may be configured to receive a RACH configuration for a RACH procedure with the network node. The RACH configuration may be received via at least one of a SIB and/or RRC signaling. In some aspects, the RACH configuration may indicate at least one of a number of a plurality of preamble messages to be transmitted for the RACH procedure and/or a number of a set of spatial domain filters to be used for transmission of the plurality of preamble messages. In some other aspects, the RACH configuration may indicate one or more thresholds to be satisfied in order for a spatial domain filter to be used for RACH preamble transmission. In still other aspects, the RACH configuration may indicate whether the plurality of preamble messages is to include the same preamble or at least two different preambles.

In the context of FIG. 4, for example, the UE 404 may receive the RACH configuration 426 from the base station 402.

At 608, the UE may determine whether each of the set of signal strength measurements satisfies at least one threshold. For example, the UE may compare each of the signal strength measurements to the at least one threshold, and the UE may determine that a signal strength measurement satisfies the at least one threshold when the signal strength measurement meets or exceeds the at least one threshold. The UE may receive at least one threshold in the RACH configuration. For example, the at least one threshold may be a downlink reference signal RSRP threshold, such as rsrp-ThresholdSSB or rsrp-ThresholdCSI-RS. In another example, the at least one threshold may be another threshold, in addition to the downlink reference signal RSRP threshold, that is suitable for selection of downlink reference signal resources for configured spatial domain filters.

In the context of FIG. 4, for example, the UE 404 may determine whether each of the set of signal strength measurements measured from the reference signals 422a-422c satisfies at least one threshold, which may be indicated by the RACH configuration 426.

At 610, the UE may determine a set of spatial domain filters for the RACH procedure based on the RACH configuration. Each respective spatial domain filter of the set of spatial domain filters may correspond to a respective reference signal of the set of reference signals. For example, each of the set spatial domain filters may be indexed with a unique integer value. In some aspects, the UE may select the set of spatial domain filters for the RACH procedure based on the RACH configuration by, identifying the number of spatial domain filters indicated by the RACH configuration, which may be the number of spatial domain filters configured for the UE by the network node. In addition, if the number of signal strength measurements satisfying the at least one threshold is greater than or equal to the number of configured spatial domain filters, then the UE may select a set of spatial domain filters respectively corresponding to received reference signals for which those threshold-satisfying signal strength measurements were measured. Otherwise, the UE may highest threshold-satisfying signal strength measurements were measured, where Y<Z. The selected spatial domain filters may be selected or organized in the order (e.g., numerical order) of respective associated indices. By way of illustration, if the number of signal strength measurements satisfying the at least one threshold is greater than the number Y of configured spatial domain filters, then the UE may select a set of Y spatial domain filters that respectively correspond to Y received reference signals for which the Y highest threshold-satisfying signal strength measurements were measured. If the number of signal strength measurements satisfying the at least one threshold is less than the number Y of configured spatial domain filters, then the UE may select a set of Z spatial domain filters that respectively correspond to Z received reference signals for which the Z highest threshold-satisfying signal strength measurements were measured, where Y<Z. The selected spatial domain filters may be selected or organized in the order (e.g., numerical order) of respective associated indices. The order may be arranged as ascending or descending.

In the context FIG. 4, for example, the UE 404 may determine a set of spatial domain filters respectively corresponding to the UE beams 414 (which may be respectively paired with the base station beams 412) based on the RACH configuration 426. The UE 404 may determine the set of spatial domain filters further based on the measurement information 424.

At 612, the UE may perform a RACH procedure with the network node. For example, the UE may transmit a plurality of preamble messages to the network node, and then the UE may receive a random access response from the network node in response to at least one of the plurality of preamble messages.

In the context FIG. 4, for example, the UE 404 may perform a RACH procedure with the base station 402 based on the RACH configuration 426 using the determined set of spatial domain filters.

At 614, the UE may perform the RACH procedure by transmitting, to the network node, the plurality of preamble messages for the RACH procedure using the set of spatial domain filters. In some aspects, the plurality of preamble messages includes at least one of one or more instances of a first preamble message, or one or more instances of a second preamble message. For example, the plurality of preamble messages may all include the same preamble or at least two different preambles. In some aspects, to transmit the plurality of preamble messages using the set of spatial domain filters based on the RACH configuration, the UE may transmit one or more instances of a first preamble message using a first spatial domain filter of the set of spatial domain filters based on the RACH configuration. In some aspects, the UE may transmit one or more instances of the first preamble message using a second spatial domain filter of the set of spatial domain filters based on the RACH configuration. In some aspects, the UE may transmit one or more instances of a second preamble message using a second spatial domain filter of the set of spatial domain filters based on the RACH configuration. In some other aspects, when a number of the set of signal strength measurements is less than a number of configured spatial domain filters, the UE may respectively transmit the plurality of preamble messages using the set of spatial domain filters based on a set of indices with which the set of spatial domain filters is respectively configured. In some aspects, the UE may multiplex at least two of the plurality of preamble messages in at least one of time or frequency.

In the context FIG. 4, for example, the UE 404 may transmit, to the base station 402, the preamble messages 430a-430d for the RACH procedure using the set of spatial domain filters, which may correspond to the UE beams 414. In the context of FIGS. 5A and 5B, for example, the UE 404 may multiplex the first preamble message 430a and second preamble message 430b in the frequency domain, while the first and second preamble messages 430a, 430b may overlap in the time domain. The UE 404 may use the first spatial domain filter 570a to transmit the first and second preamble messages 430a, 430b, and therefore, the first and second preamble messages 430a, 430b may overlap in the spatial domain. However, the UE 404 may multiplex the first preamble message 430a and third preamble message 430c in the time domain, while the first and third preamble messages 430a, 430c may overlap in the frequency domain. The UE 404 may use the first spatial domain filter 570a to transmit the first preamble message 430a but may use the second spatial domain filter 570b to transmit the third preamble message 430c, and therefore, the first and third preamble messages 430a, 430c may be separated in the spatial domain.

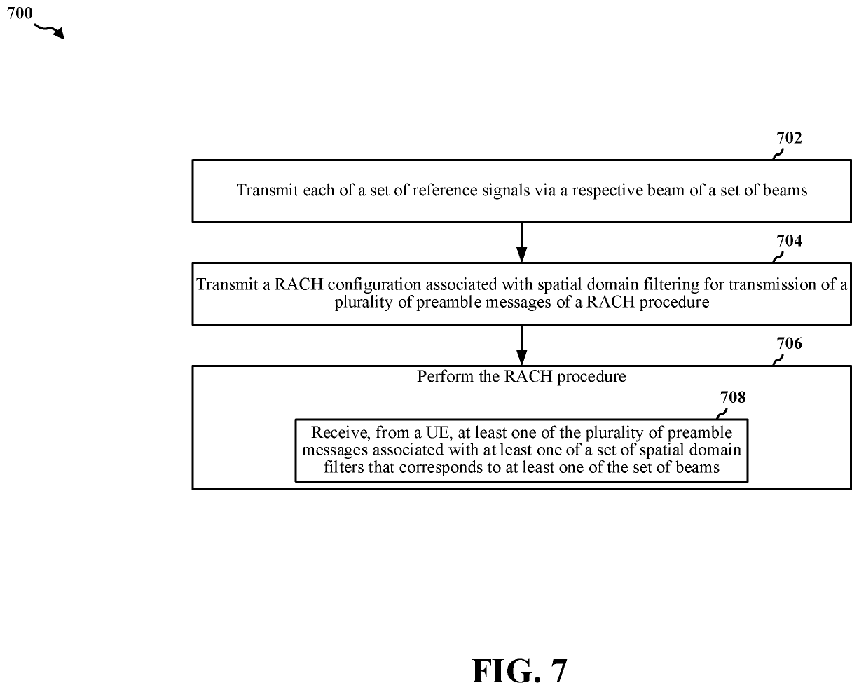

FIG. 7 is a flowchart 700 of a method of wireless communication. The method may be performed by or at a network node (e.g., the base station 102/180, 310, 402), another wireless communications apparatus (e.g., the apparatus 902), or one or more components thereof. According to various different aspects, one or more of the illustrated blocks may be omitted, transposed, and/or contemporaneously performed.

At 702, the network node may transmit each of a set of reference signals via a respective beam of a set of beams. In some aspects, the set of reference signals may include a set of SSBs. In some other aspects, the set of reference signals may include a set of CSI-RSs. In still other aspects, the set of reference signals may include one subset of SSBs and another subset of CSI-RSs.

In the context of FIG. 4, for example, the base station 402 may transmit a set of reference signals 422a-422c via the set of base station beams 412. The UE 404 may receive the set of reference signals 422a-422c via the set of UE beams 414 corresponding to spatial domain filters at the UE 404.

At 704, the network node may be configured to transmit a RACH configuration associated with spatial domain filtering for transmission of a plurality of preamble messages of a RACH procedure. The RACH configuration may be transmitted via at least one of a SIB and/or RRC signaling. In some aspects, the RACH configuration may indicate at least one of a number of a plurality of preamble messages to be transmitted for the RACH procedure and/or a number of a set of spatial domain filters to be used for transmission of the plurality of preamble messages. In some other aspects, the RACH configuration may indicate one or more thresholds to be satisfied in order for a spatial domain filter to be used for RACH preamble transmission. In still other aspects, the RACH configuration may indicate whether the plurality of preamble messages is to include the same preamble or at least two different preambles.

In the context of FIG. 4, for example, the base station 402 may transmit the RACH configuration 426 configuring spatial domain filtering of a plurality of preamble messages 430a-430d associated with a RACH procedure.

At 706, the network node may perform a RACH procedure with the UE (e.g., another network node). For example, the network node may receive at least one of a plurality of preamble messages transmitted by the UE, and then the network node may transmit a random access response to the UE in response to the at least one of the plurality of preamble messages.

In the context FIG. 4, for example, the UE 404 may perform a RACH procedure with the base station 402 based on the RACH configuration 426 using the determined set of spatial domain filters.

At 708, the network node may perform the RACH procedure by receiving, from a UE, at least one of the plurality of preamble messages associated with at least one of a set of spatial domain filters that corresponds to at least one of the set of beams. For example, the network node may receive at least one of the plurality of preamble messages transmitted by the UE, and the network node may identify the UE based on the received preamble message. The plurality of preamble messages may be respectively associated with the set of spatial domain filters. In some aspects, at least two of the plurality of preamble messages are associated with a same spatial domain filter of the set of spatial domain filters based on the RACH configuration. In some aspects, the at least one of the plurality of preamble messages includes at least one of one or more instances of a first preamble message, or one or more instances of a second preamble message. For example, the plurality of preamble messages may all include the same preamble or at least two different preambles. In some aspects, the network node may receive one or more instances of a first preamble message associated with a first spatial domain filter of the set of spatial domain filters based on the RACH configuration. In some aspects, the network node may receive one or more instances of the first preamble message associated with a second spatial domain filter of the set of spatial domain filters based on the RACH configuration. In some aspects, the network node may receive one or more instances of a second preamble message associated with a second spatial domain filter of the set of spatial domain filters based on the RACH configuration. In some aspects, at least two of the plurality of preamble messages are multiplexed in at least one of time or frequency. In still other aspects, at least one of the plurality of preamble messages is respectively received based on a set of indices with which the set of spatial domain filters is respectively configured.

In the context of FIG. 4, for example, the base station 402 may perform the RACH procedure by receiving, from the UE 404, at least one of the plurality of preamble messages 430a-430d associated with at least one of a set of spatial domain filters that corresponds to at least one of the set of UE beams 414 that may be paired with one of the set of base station beams 412. In the context of FIGS. 5A and 5B, for example, the base station 402 may receive the first preamble message 430a and second preamble message 430b multiplexed in the frequency domain, while the first and second preamble messages 430a, 430b may overlap in the time domain. The first spatial domain filter 570a may be used to transmit the first and second preamble messages 430a, 430b, and therefore, the first and second preamble messages 430a, 430b may overlap in the spatial domain. However, the base station 402 may receive the first preamble message 430a and third preamble message 430c multiplexed in the time domain, while the first and third preamble messages 430a, 430c may overlap in the frequency domain. The first spatial domain filter 570a may be used to transmit the first preamble message 430a but the second spatial domain filter 570b may be used to transmit the third preamble message 430c, and therefore, the first and third preamble messages 430a, 430c may be separated in the spatial domain.

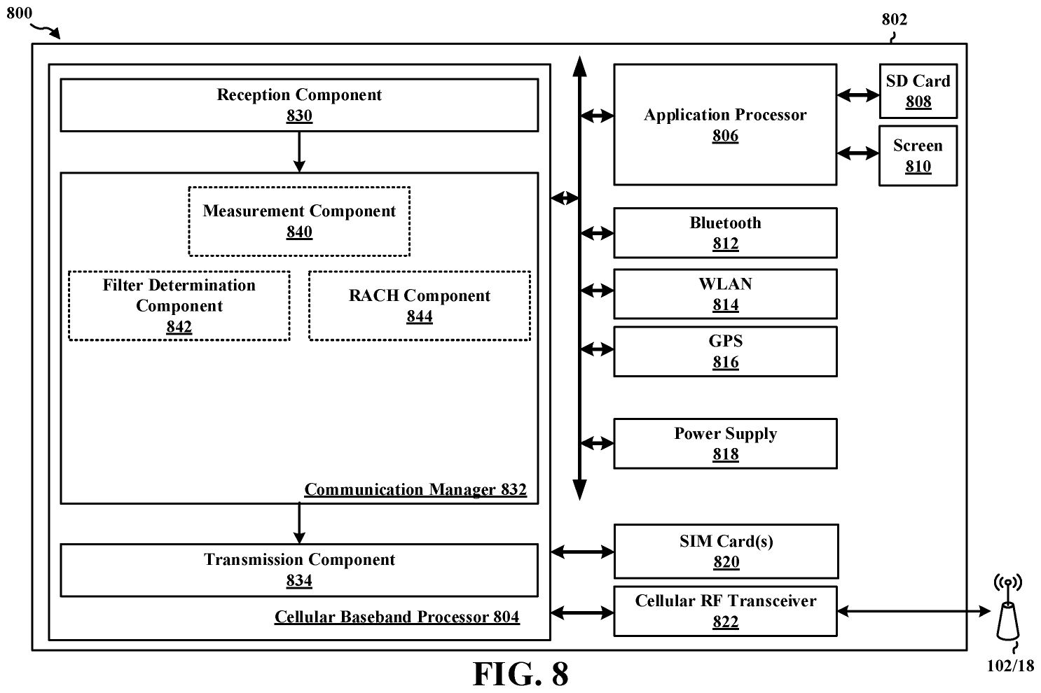

FIG. 8 is a diagram 800 illustrating an example of a hardware implementation for an apparatus 802. The apparatus 802 may be a UE or similar device, or the apparatus 802 may be a component of a UE or similar device. The apparatus 802 may include a cellular baseband processor 804 (also referred to as a modem) and/or a cellular RF transceiver 822, which may be coupled together and/or integrated into the same package, component, circuit, chip, and/or other circuitry.

In some aspects, the apparatus 802 may accept or may include one or more subscriber identity modules (SIM) cards 820, which may include one or more ICs, chips, or similar circuitry, and which may be removable or embedded. The one or more SIM cards 820 may carry identification and/or authentication information, such as an international mobile subscriber identity (IMSI) and/or IMSI-related key(s). Further, the apparatus 802 may include one or more of an application processor 806 coupled to a secure digital (SD) card 808 and a screen 810, a Bluetooth module 812, a wireless local area network (WLAN) module 814, a Global Positioning System (GPS) module 816, and/or a power supply 818.

The cellular baseband processor 804 communicates through the cellular RF transceiver 822 with the UE 104 and/or base station 102/180. The cellular baseband processor 804 may include a computer-readable medium/memory. The computer-readable medium/memory may be non-transitory. The cellular baseband processor 804 is responsible for general processing, including the execution of software stored on the computer-readable medium/memory. The software, when executed by the cellular baseband processor 804, causes the cellular baseband processor 804 to perform the various functions described supra. The computer-readable medium/memory may also be used for storing data that is manipulated by the cellular baseband processor 804 when executing software. The cellular baseband processor 804 further includes a reception component 830, a communication manager 832, and a transmission component 834. The communication manager 832 includes the one or more illustrated components. The components within the communication manager 832 may be stored in the computer-readable medium/memory and/or configured as hardware within the cellular baseband processor 804.

In the context of FIG. 3, the cellular baseband processor 804 may be a component of the UE 350 and may include the memory 360 and/or at least one of the TX processor 368, the RX processor 356, and/or the controller/processor 359. In one configuration, the apparatus 802 may be a modem chip and/or may be implemented as the baseband processor 804, while in another configuration, the apparatus 802 may be the entire UE (e.g., the UE 350 of FIG. 3) and may include some or all of the abovementioned components, circuits, chips, and/or other circuitry illustrated in the context of the apparatus 802. In one configuration, the cellular RF transceiver 822 may be implemented as at least one of the transmitter 354TX and/or the receiver 354RX.

The reception component 830 may be configured to receive signaling on a wireless channel, such as signaling from a base station 102/180 or UE 104. The transmission component 834 may be configured to transmit signaling on a wireless channel, such as signaling to a base station 102/180 or UE 104. The communication manager 832 may coordinate or manage some or all wireless communications by the apparatus 802, including across the reception component 830 and the transmission component 834.

The reception component 830 may provide some or all data and/or control information included in received signaling to the communication manager 832, and the communication manager 832 may generate and provide some or all of the data and/or control information to be included in transmitted signaling to the transmission component 834. The communication manager 832 may include the various illustrated components, including one or more components configured to process received data and/or control information, and/or one or more components configured to generate data and/or control information for transmission.

The communication manager 832 may include a measurement component 840, a filter determination component 842, and/or a RACH component 844.

The reception component 830 may be configured to receive a RACH configuration for a RACH procedure with the base station 102/180, e.g., as described in connection with 602 of FIG. 6. The RACH configuration may be received via at least one of a SIB and/or RRC signaling. In some aspects, the RACH configuration may indicate at least one of a number of a plurality of preamble messages to be transmitted for the RACH procedure and/or a number of a set of spatial domain filters to be used for transmission of the plurality of preamble messages. In some other aspects, the RACH configuration may indicate one or more thresholds to be satisfied in order for a spatial domain filter to be used for RACH preamble transmission. In still other aspects, the RACH configuration may indicate whether the plurality of preamble messages is to include the same preamble or at least two different preambles.

The reception component 830 may be further configured to receive a set of reference signals from the base station 102/180, e.g., as described in connection with 604 of FIG. 6. In some aspects, each of the set of reference signals may correspond to a respective spatial domain filter. In some aspects, the set of reference signals received from the base station 102/180 may include a set of SSBs. In some other aspects, the set of reference signals received from the base station 102/180 may include a set of CSI-RSs. In still other aspects, the set of reference signals received from the base station 102/180 may include one subset of SSBs and another subset of CSI-RSs.

The measurement component 840 may be configured to determine a respective signal strength measurement of a set of signal strength measurements for each reference signal of the set of reference signals, e.g., as described in connection with 606 of FIG. 6. For example, the measurement component 840 may detect energy on a set of resources carrying each reference signal, and the measurement component 840 may measure the energy that corresponds to the reference signal. Each of the set of signal strength measurements may be or may include an RSRP (e.g., L1-RSRP), SNR (e.g., L1-SNR), RSRQ, SINR, RSSI, and/or another similar measurement indicative of channel quality and/or energy detected on channel resources.

The measurement component 840 may be further configured to determine whether each of the set of signal strength measurements satisfies at least one threshold, e.g., as described in connection with 608 of FIG. 6. For example, the measurement component 840 may compare each of the signal strength measurements to the at least one threshold, and the measurement component 840 may determine that a signal strength measurement satisfies the at least one threshold when the signal strength measurement meets or exceeds the at least one threshold. The measurement component 840 may receive at least one threshold in the RACH configuration. For example, the at least one threshold may be a downlink reference signal RSRP threshold, such as rsrp-ThresholdSSB or rsrp-ThresholdCSI-RS. In another example, the at least one threshold may be another threshold, in addition to the downlink reference signal RSRP threshold, that is suitable for selection of downlink reference signal resources for configured spatial domain filters.

The filter determination component 842 may be configured to determine a set of spatial domain filters for the RACH procedure based on the RACH configuration, e.g., as described in connection with 610 of FIG. 6. Each respective spatial domain filter of the set of spatial domain filters may correspond to a respective reference signal of the set of reference signals. For example, each of the set spatial domain filters may be indexed with a unique integer value. In some aspects, the filter determination component 842 may select the set of spatial domain filters for the RACH procedure based on the RACH configuration by, identifying the number of spatial domain filters indicated by the RACH configuration, which may be the number of spatial domain filters configured for the apparatus 802 by the base station 102/180. In addition, if the number of signal strength measurements satisfying the at least one threshold is greater than or equal to the number of configured spatial domain filters, then the filter determination component 842 may select a set of spatial domain filters respectively corresponding to received reference signals for which those threshold-satisfying signal strength measurements were measured. Otherwise, the filter determination component 842 may highest threshold-satisfying signal strength measurements were measured, where Y<Z. The selected spatial domain filters may be selected or organized in the order (e.g., numerical order) of respective associated indices. By way of illustration, if the number of signal strength measurements satisfying the at least one threshold is greater than the number Y of configured spatial domain filters, then the filter determination component 842 may select a set of Y spatial domain filters that respectively correspond to Y received reference signals for which the Y highest threshold-satisfying signal strength measurements were measured. If the number of signal strength measurements satisfying the at least one threshold is less than the number Y of configured spatial domain filters, then the filter determination component 842 may select a set of Z spatial domain filters that respectively correspond to Z received reference signals for which the Z highest threshold-satisfying signal strength measurements were measured, where Y<Z. The selected spatial domain filters may be selected or organized in the order (e.g., numerical order) of respective associated indices. The order may be arranged as ascending or descending.

The RACH component 844 may be configured to perform a RACH procedure with the base station 102/180, e.g., as described in connection with 612 of FIG. 6. For example, the RACH component 844 may transmit a plurality of preamble messages to the base station 102/180, and then the RACH component 844 may receive a random access response from the base station 102/180 in response to at least one of the plurality of preamble messages.

The RACH component 844 may perform the RACH procedure by transmitting, to the base station 102/180, the plurality of preamble messages for the RACH procedure using the set of spatial domain filters, e.g., as described in connection with 614 of FIG. 6. In some aspects, the plurality of preamble messages includes at least one of one or more instances of a first preamble message, or one or more instances of a second preamble message. For example, the plurality of preamble messages may all include the same preamble or at least two different preambles. In some aspects, to transmit the plurality of preamble messages using the set of spatial domain filters based on the RACH configuration, the RACH component 844 may transmit one or more instances of a first preamble message using a first spatial domain filter of the set of spatial domain filters based on the RACH configuration. In some aspects, the RACH component 844 may transmit one or more instances of the first preamble message using a second spatial domain filter of the set of spatial domain filters based on the RACH configuration. In some aspects, the RACH component 844 may transmit one or more instances of a second preamble message using a second spatial domain filter of the set of spatial domain filters based on the RACH configuration. In some other aspects, when a number of the set of signal strength measurements is less than a number of configured spatial domain filters, the RACH component 844 may respectively transmit the plurality of preamble messages using the set of spatial domain filters based on a set of indices with which the set of spatial domain filters is respectively configured. In some aspects, the RACH component 844 may multiplex at least two of the plurality of preamble messages in at least one of time or frequency.

The apparatus 802 may include additional components that perform some or all of the blocks, operations, signaling, etc. of the algorithms in the aforementioned call flow diagram and/or flowchart of FIGS. 4 and/or 6. As such, some or all of the blocks, operations, signaling, etc. in the aforementioned call flow diagram and/or flowchart of FIGS. 4 and/or 6 may be performed by one or more components and the apparatus 802 may include one or more such components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 802, and in particular the cellular baseband processor 804, includes means for receiving a RACH configuration for a RACH procedure with a base station 102/180; means for determining a set of spatial domain filters for the RACH procedure based on the RACH configuration, and each respective spatial domain filter of the set of spatial domain filters corresponds to a respective reference signal of a set of reference signals; and means for performing the RACH procedure, and, the means for performing the RACH procedure is configured to transmit, to the base station 102/180, a plurality of preamble messages using the set of spatial domain filters based on the RACH configuration.

In one configuration, the apparatus 802, and in particular the cellular baseband processor 804, includes means for receiving the set of reference signals from the base station 102/180.

In one configuration, to transmit the plurality of preamble messages using the set of spatial domain filters based on the RACH configuration, the means for performing the RACH procedure is configured to transmit at least two preamble messages of the plurality of preamble messages using a same spatial domain filter of the set of spatial domain filters based on the RACH configuration.

In one configuration, the RACH configuration indicates at least one of a number of the plurality of preamble messages or a number of the set of spatial domain filters.

In one configuration, the means for receiving the RACH configuration is configured to receive the RACH configuration via one of a SIB or RRC signaling.

In one configuration, the set of reference signals includes at least one of a SSB or a CSI-RS.

In one configuration, a first subset of the set of reference signals includes a set of SSBs and a second subset of the set of reference signals includes a set of CSI-RSs.

In one configuration, the apparatus 802, and in particular the cellular baseband processor 804, includes means for determining a respective signal strength value of a set of signal strength values for each reference signal of the set of reference signals to which a respective spatial domain filter of the set spatial domain filters corresponds, and the set of spatial domain filters is determined further based on the set of signal strength values.

In one configuration, the apparatus 802, and in particular the cellular baseband processor 804, includes means for determining whether each of the set of signal strength values satisfies at least one threshold, and each of the set of spatial domain filters is determined further based on whether the respective signal strength value satisfies the at least one threshold, and the RACH configuration indicates the at least one threshold.

In one configuration, to transmit the plurality of preamble messages using the set of spatial domain filters based on the RACH configuration, the means for performing the RACH procedure is configured to transmit the plurality of preamble messages respectively using the set of spatial domain filters based on a set of indices with which the set of spatial domain filters is respectively configured when a number of the set of signal strength values that satisfy the at least one threshold is less than a number of configured spatial domain filters.

In one configuration, the plurality of preamble messages includes one of a same preamble or at least two different preambles.

In one configuration, the RACH configuration indicates whether the plurality of preamble messages is to include the same preamble or the at least two different preambles.

In one configuration, at least two of the plurality of preamble messages are multiplexed in at least one of time or frequency.

In one configuration, the plurality of preamble messages includes at least one of one or more instances of a first preamble message, or one or more instances of a second preamble message.

In one configuration, to transmit the plurality of preamble messages using the set of spatial domain filters based on the RACH configuration, the means for performing the RACH procedure is configured to transmit one or more instances of a first preamble message using a first spatial domain filter of the set of spatial domain filters based on the RACH configuration.

In one configuration, to transmit the plurality of preamble messages using the set of spatial domain filters based on the RACH configuration, the means for performing the RACH procedure is configured to transmit one or more instances of the first preamble message using a second spatial domain filter of the set of spatial domain filters based on the RACH configuration.

In one configuration, to transmit the plurality of preamble messages using the set of spatial domain filters based on the RACH configuration, the means for performing the RACH procedure is configured to transmit one or more instances of a second preamble message using a second spatial domain filter of the set of spatial domain filters based on the RACH configuration.

The aforementioned means may be one or more of the aforementioned components of the apparatus 802 configured to perform the functions recited by the aforementioned means. As described supra, the apparatus 802 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

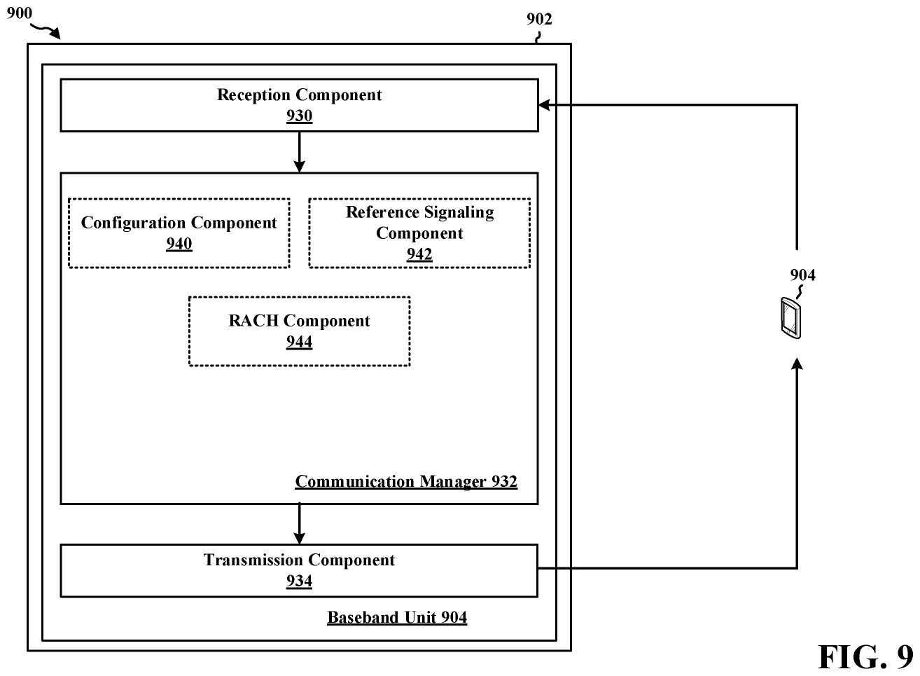

FIG. 9 is a diagram 900 illustrating an example of a hardware implementation for an apparatus 902. The apparatus 902 may be a base station, a network node, or similar device or system, or the apparatus 902 may be a component of a base station, a network node, or similar device or system. The apparatus 902 may include a baseband unit 904. The baseband unit 904 may communicate through a cellular RF transceiver. For example, the baseband unit 904 may communicate through a cellular RF transceiver with a UE 104, such as for downlink and/or uplink communication, and/or with a base station 102/180, such as for IAB.

The baseband unit 904 may include a computer-readable medium/memory, which may be non-transitory. The baseband unit 904 is responsible for general processing, including the execution of software stored on the computer-readable medium/memory. The software, when executed by the baseband unit 904, causes the baseband unit 904 to perform the various functions described supra. The computer-readable medium/memory may also be used for storing data that is manipulated by the baseband unit 904 when executing software. The baseband unit 904 further includes a reception component 930, a communication manager 932, and a transmission component 934. The communication manager 932 includes the one or more illustrated components. The components within the communication manager 932 may be stored in the computer-readable medium/memory and/or configured as hardware within the baseband unit 904. The baseband unit 904 may be a component of the base station 310 and may include the memory 376 and/or at least one of the TX processor 316, the RX processor 370, and the controller/processor 375.

The reception component 930 may be configured to receive signaling on a wireless channel, such as signaling from a UE 104 or base station 102/180. The transmission component 934 may be configured to transmit signaling on a wireless channel, such as signaling to a UE 104 or base station 102/180. The communication manager 932 may coordinate or manage some or all wireless communications by the apparatus 902, including across the reception component 930 and the transmission component 934.

The reception component 930 may provide some or all data and/or control information included in received signaling to the communication manager 932, and the communication manager 932 may generate and provide some or all of the data and/or control information to be included in transmitted signaling to the transmission component 934. The communication manager 932 may include the various illustrated components, including one or more components configured to process received data and/or control information, and/or one or more components configured to generate data and/or control information for transmission. In some aspects, the generation of data and/or control information may include packetizing or otherwise reformatting data and/or control information received from a core network, such as the core network 190 or the EPC 160, for transmission.

The communication manager 932 may include a configuration component 940, a reference signaling component 942, and/or a RACH component 944.

The configuration component 940 may be configured to generate and transmit a RACH configuration associated with spatial domain filtering for transmission of a plurality of preamble messages of a RACH procedure, e.g., as described in connection with 702 of FIG. 7. The RACH configuration may be transmitted via at least one of a SIB and/or RRC signaling. In some aspects, the RACH configuration may indicate at least one of a number of a plurality of preamble messages to be transmitted for the RACH procedure and/or a number of a set of spatial domain filters to be used for transmission of the plurality of preamble messages. In some other aspects, the RACH configuration may indicate one or more thresholds to be satisfied in order for a spatial domain filter to be used for RACH preamble transmission. In still other aspects, the RACH configuration may indicate whether the plurality of preamble messages is to include the same preamble or at least two different preambles.

The reference signaling component 942 may be configured to transmit each of a set of reference signals via a respective beam of a set of beams, e.g., as described in connection with 704 of FIG. 7. In some aspects, the set of reference signals may include a set of SSBs. In some other aspects, the set of reference signals may include a set of CSI-RSs. In still other aspects, the set of reference signals may include one subset of SSBs and another subset of CSI-RSs.

The RACH component 944 may be configured to perform a RACH procedure with the UE 104, e.g., as described in connection with 706 of FIG. 7. For example, the RACH component 944 may receive at least one of a plurality of preamble messages transmitted by the UE 104, and then the RACH component 944 may transmit a random access response to the UE 104 in response to the at least one of the plurality of preamble messages.

The RACH component 944 may perform the RACH procedure by receiving, from a UE 104, at least one of the plurality of preamble messages associated with at least one of a set of spatial domain filters that corresponds to at least one of the set of beams, e.g., as described in connection with 708 of FIG. 7. For example, the RACH component 944 may receive at least one of the plurality of preamble messages transmitted by the UE, and the RACH component 944 may identify the UE 104 based on the received preamble message. The plurality of preamble messages may be respectively associated with the set of spatial domain filters. In some aspects, at least two of the plurality of preamble messages are associated with a same spatial domain filter of the set of spatial domain filters based on the RACH configuration. In some aspects, the at least one of the plurality of preamble messages includes at least one of one or more instances of a first preamble message, or one or more instances of a second preamble message. For example, the plurality of preamble messages may all include the same preamble or at least two different preambles. In some aspects, the RACH component 944 may receive one or more instances of a first preamble message associated with a first spatial domain filter of the set of spatial domain filters based on the RACH configuration. In some aspects, the RACH component 944 may receive one or more instances of the first preamble message associated with a second spatial domain filter of the set of spatial domain filters based on the RACH configuration. In some aspects, the RACH component 944 may receive one or more instances of a second preamble message associated with a second spatial domain filter of the set of spatial domain filters based on the RACH configuration. In some aspects, at least two of the plurality of preamble messages are multiplexed in at least one of time or frequency. In still other aspects, at least one of the plurality of preamble messages is respectively received based on a set of indices with which the set of spatial domain filters is respectively configured.

The apparatus 902 may include additional components that perform some or all of the blocks, operations, signaling, etc. of the algorithms in the aforementioned call flow diagram and flowchart of FIGS. 4 and 7. As such, some or all of the blocks, operations, signaling, etc. in the aforementioned call flow diagram and/or flowchart of FIGS. 4 and 7 may be performed by a component and the apparatus 902 may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 902, and in particular the baseband unit 904, includes means for transmitting each of a set of reference signals via a respective beam of a set of beams; means for transmitting a RACH configuration associated with spatial domain filtering for transmission of a plurality of preamble messages of a RACH procedure; and means for performing the RACH procedure, and the means for performing the RACH procedure is configured to receive, from a UE 104, at least one of the plurality of preamble messages associated with at least one of a set of spatial domain filters that corresponds to at least one set of the set of beams.

In one configuration, the RACH configuration indicates at least one of a number of the plurality of preamble messages or a number of the set of spatial domain filters.

In one configuration, the apparatus 902, and in particular the baseband unit 904, includes means for transmitting the RACH configuration via one of a SIB or radio RRC signaling.

In one configuration, the set of reference signals includes at least one of a SSB or a CSI-RS.

In one configuration, a first subset of the set of reference signals includes a set of SSBs and a second subset of the set of reference signals includes a set of CSI-RSs.

In one configuration, the plurality of preamble messages includes one of a same preamble or at least two different preambles.

In one configuration, the RACH configuration indicates whether the plurality of preamble messages is to include the same preamble or the at least two different preambles.

In one configuration, to receive, from the UE 104, the at least one of the plurality of preamble messages associated with the at least one of the set of spatial domain filters that corresponds to the at least one set of the set of beams, the means for performing the RACH procedure is configured to receive at least two of the plurality of preamble messages that are multiplexed in at least one of time or frequency.

In one configuration, the at least one of the plurality of preamble messages includes at least one of: one or more instances of a first preamble message; or one or more instances of a second preamble message.

In one configuration, to receive, from the UE 104, the at least one of the plurality of preamble messages associated with the at least one of the set of spatial domain filters that corresponds to the at least one set of the set of beams, the means for performing the RACH procedure is configured to receive one or more instances of a first preamble message associated with a first spatial domain filter of the set of spatial domain filters based on the RACH configuration.

In one configuration, to receive, from the UE 104, the at least one of the plurality of preamble messages associated with the at least one of the set of spatial domain filters that corresponds to the at least one set of the set of beams, the means for performing the RACH procedure is configured to receive one or more instances of the first preamble message associated with a second spatial domain filter of the set of spatial domain filters based on the RACH configuration.

In one configuration, to receive, from the UE 104, the at least one of the plurality of preamble messages associated with the at least one of the set of spatial domain filters that corresponds to the at least one set of the set of beams, the means for performing the RACH procedure is configured to receive one or more instances of a second preamble message associated with a second spatial domain filter of the set of spatial domain filters based on the RACH configuration.

In one configuration, the RACH configuration indicates at least one threshold associated with the set of reference signals respectively corresponding to the at least one of the set of spatial domain filters.

The aforementioned means may be one or more of the aforementioned components of the apparatus 902 configured to perform the functions recited by the aforementioned means. As described supra, the apparatus 902 may include the TX Processor 316, the RX Processor 370, and the controller/processor 375. As such, in one configuration, the aforementioned means may be the TX Processor 316, the RX Processor 370, and the controller/processor 375 configured to perform the functions recited by the aforementioned means.

The specific order or hierarchy of blocks or operations in each of the foregoing processes, flowcharts, and other diagrams disclosed herein is an illustration of example approaches. Based upon design preferences, the specific order or hierarchy of blocks or operations in each of the processes, flowcharts, and other diagrams may be rearranged, omitted, and/or contemporaneously performed without departing from the scope of the present disclosure. Further, some blocks or operations may be combined or omitted. The accompanying method claims present elements of the various blocks or operations in a sample order, and are not meant to be limited to the specific order or hierarchy presented.

The following examples are illustrative only and may be combined with aspects of other embodiments or teachings described herein, without limitation.

Example 1 may be a method of wireless communication at a first network node including: receiving a RACH configuration for a RACH procedure with a second network node; determining a set of spatial domain filters for the RACH procedure based on the RACH configuration, and each respective spatial domain filter of the set of spatial domain filters corresponds to a respective reference signal of a set of reference signals; and performing the RACH procedure, and performing the RACH procedure includes transmitting, to the second network node, a plurality of preamble messages using the set of spatial domain filters based on the RACH configuration.

Example 2 may include the method of Example 1, and further including: receiving the set of reference signals from the second network node.

Example 3 may include the method of any of Examples 1 to 2, and transmitting the plurality of preamble messages using the set of spatial domain filters based on the RACH configuration includes: transmitting at least two preamble messages of the plurality of preamble messages using a same spatial domain filter of the set of spatial domain filters based on the RACH configuration.

Example 4 may include the method of any of Examples 1 to 3, and the RACH configuration indicates at least one of a number of the plurality of preamble messages or a number of the set of spatial domain filters.

Example 5 may include the method of Examples 1 to 4, and receiving the RACH configuration includes: receiving the RACH configuration via one of a SIB or RRC signaling.

Example 6 may include the method of any of Examples 1 to 5, and the set of reference signals includes at least one of a SSB or a CSI-RS.

Example 7 may include the method of Example 6, and a first subset of the set of reference signals includes a set of SSBs and a second subset of the set of reference signals includes a set of CSI-RSs.

Example 8 may include the method of any of Examples 1 to 7, and further including: determining a respective signal strength value of a set of signal strength values for each reference signal of the set of reference signals to which a respective spatial domain filter of the set spatial domain filters corresponds, and the set of spatial domain filters is determined further based on the set of signal strength values.

Example 9 may include the method of Example 8, further including: determining whether each of the set of signal strength values satisfies at least one threshold, and each of the set of spatial domain filters is determined further based on whether the respective signal strength value satisfies the at least one threshold, and the RACH configuration indicates the at least one threshold.

Example 10 may include the method of any of Examples 1 to 9, and transmitting the plurality of preamble messages using the set of spatial domain filters based on the RACH configuration includes: transmitting the plurality of preamble messages respectively using the set of spatial domain filters based on a set of indices with which the set of spatial domain filters is respectively configured when a number of the set of signal strength values that satisfy the at least one threshold is less than a number of configured spatial domain filters.

Example 11 may include the method of any of Examples 1 to 10, and the plurality of preamble messages includes one of a same preamble or at least two different preambles.

Example 12 may include the method of any of Examples 1 to 11, and the RACH configuration indicates whether the plurality of preamble messages is to include the same preamble or the at least two different preambles.

Example 13 may include the method of Example 1, and at least two of the plurality of preamble messages are multiplexed in at least one of time or frequency.

Example 14 may include the method of any of Examples 1 to 13, and the plurality of preamble messages includes at least one of: one or more instances of a first preamble message; or one or more instances of a second preamble message.

Example 15 may include the method of any of Examples 1 to 13, and transmitting the plurality of preamble messages using the set of spatial domain filters based on the RACH configuration includes: transmitting one or more instances of a first preamble message using a first spatial domain filter of the set of spatial domain filters based on the RACH configuration.

Example 16 may include the method of Example 15, and transmitting the plurality of preamble messages using the set of spatial domain filters based on the RACH configuration includes: transmitting one or more instances of the first preamble message using a second spatial domain filter of the set of spatial domain filters based on the RACH configuration.

Example 17 may include the method of Example 15, and transmitting the plurality of preamble messages using the set of spatial domain filters based on the RACH configuration includes: transmitting one or more instances of a second preamble message using a second spatial domain filter of the set of spatial domain filters based on the RACH configuration.

Example 18 may include a method of wireless communication including: transmitting each of a set of reference signals via a respective beam of a set of beams; transmitting a RACH configuration associated with spatial domain filtering for transmission of a plurality of preamble messages of a RACH procedure; and performing the RACH procedure, and performing the RACH procedure includes: receiving, from a second network node, at least one of the plurality of preamble messages associated with at least one of a set of spatial domain filters that corresponds to at least one set of the set of beams.

Example 19 may include the method of Example 18, and the RACH configuration indicates at least one of a number of the plurality of preamble messages or a number of the set of spatial domain filters.

Example 20 may include the method of any of Examples 18 to 19, and transmitting the RACH configuration includes: transmitting the RACH configuration via one of a SIB or RRC signaling.

Example 21 may include the method of any of Examples 18 to 20, and the set of reference signals includes at least one of a SSB or a CSI-RS.

Example 22 may include the method of Example 21, and a first subset of the set of reference signals includes a set of SSBs and a second subset of the set of reference signals includes a set of CSI-RSs.

Example 23 may include the method of any of Examples 18 to 22, and the plurality of preamble messages includes one of a same preamble or at least two different preambles.

Example 24 may include the method of any of Examples 18 to 19, and the RACH configuration indicates whether the plurality of preamble messages is to include the same preamble or the at least two different preambles.

Example 25 may include the method of any of Examples 18 to 24, and receiving, from the second network node, the at least one of the plurality of preamble messages associated with the at least one of the set of spatial domain filters that corresponds to the at least one set of the set of beams, the at least one processor includes receiving at least two of the plurality of preamble messages that are multiplexed in at least one of time or frequency.

Example 26 may include the method of any of Examples 18 to 26, and the at least one of the plurality of preamble messages includes at least one of: one or more instances of a first preamble message; or one or more instances of a second preamble message.

Example 27 may include the method of any of Examples 18 to 26, and receiving, from the second network node, the at least one of the plurality of preamble messages associated with the at least one of the set of spatial domain filters that corresponds to the at least one set of the set of beams, the at least one processor includes receiving one or more instances of a first preamble message associated with a first spatial domain filter of the set of spatial domain filters based on the RACH configuration.

Example 28 may include the method of Example 27, and receiving, from the second network node, the at least one of the plurality of preamble messages associated with the at least one of the set of spatial domain filters that corresponds to the at least one set of the set of beams, the at least one processor includes receiving one or more instances of the first preamble message associated with a second spatial domain filter of the set of spatial domain filters based on the RACH configuration.

Example 29 may include the method of Example 27, and receiving, from the second network node, the at least one of the plurality of preamble messages associated with the at least one of the set of spatial domain filters that corresponds to the at least one set of the set of beams, the at least one processor includes receiving one or more instances of a second preamble message associated with a second spatial domain filter of the set of spatial domain filters based on the RACH configuration.

Example 30 may include the method of any of Examples 18 to 28, and the RACH configuration indicates at least one threshold associated with the set of reference signals respectively corresponding to the at least one of the set of spatial domain filters.

The previous description is provided to enable one of ordinary skill in the art to practice the various aspects described herein. Various modifications to these aspects will be readily apparent to those having ordinary skill in the art, and the generic principles defined herein may be applied to other aspects. Thus, the claims are not intended to be limited to the aspects shown herein, but is to be accorded the full scope consistent with the language. Thus, the language employed herein is not intended to limit the scope of the claims to only those aspects shown herein, but is to be accorded the full scope consistent with the language of the claims.

As one example, the language “determining” may encompass a wide variety of actions, and so may not be limited to the concepts and aspects explicitly described or illustrated by the present disclosure. In some contexts, “determining” may include calculating, computing, processing, measuring, deriving, investigating, looking up (e.g., looking up in a table, a database or another data structure), ascertaining, resolving, selecting, choosing, establishing, and so forth. In some other contexts, “determining” may include communication and/or memory operations/procedures through which information or value(s) are acquired, such as “receiving” (e.g., receiving information), “accessing” (e.g., accessing data in a memory), “detecting,” and the like.

As another example, reference to an element in the singular is not intended to mean “one and only one” unless specifically stated, but rather “one or more.” Further, terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action or event, but rather imply that if a condition is met then another action or event will occur, but without requiring a specific or immediate time constraint or direct correlation for the other action or event to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As yet another example, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As still another example, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

What is claimed is:

1. A first network node for wireless communication, comprising:
a memory; and
at least one processor coupled to the memory, wherein the at least one processor is configured to:
receive a random access channel (RACH) configuration for a RACH procedure with a second network node;
determine a set of spatial domain filters for the RACH procedure based on the RACH configuration, wherein each respective spatial domain filter of the set of spatial domain filters corresponds to a respective reference signal of a set of reference signals; and
perform the RACH procedure, wherein, to perform the RACH procedure, the at least one processor is configured to:
transmit, to the second network node, a plurality of preamble messages using the set of spatial domain filters based on the RACH configuration.

2. The first network node of claim 1, wherein the at least one processor is further configured to:
receive the set of reference signals from the second network node.

3. The first network node of claim 1, wherein, to transmit the plurality of preamble messages using the set of spatial domain filters based on the RACH configuration, the at least one processor is configured to:
transmit at least two preamble messages of the plurality of preamble messages using a same spatial domain filter of the set of spatial domain filters based on the RACH configuration.

4. The first network node of claim 1, wherein the RACH configuration indicates at least one of a number of the plurality of preamble messages or a number of the set of spatial domain filters.

5. The first network node of claim 1, wherein, to receive the RACH configuration, the at least one processor is configured to:
receive the RACH configuration via one of a system information block (SIB) or radio resource control (RRC) signaling.

6. The first network node of claim 1, wherein the set of reference signals comprises at least one of a synchronization signal block (SSB) or a channel state information reference signal (CSI-RS).

7. The first network node of claim 6, wherein a first subset of the set of reference signals comprises a set of SSBs and a second subset of the set of reference signals comprises a set of CSI-RSs.

8. The first network node of claim 1, wherein the at least one processor is configured to:
determine a respective signal strength value of a set of signal strength values for each reference signal of the set of reference signals to which a respective spatial domain filter of the set spatial domain filters corresponds, wherein the set of spatial domain filters is determined further based on the set of signal strength values.

9. The first network node of claim 8, wherein the at least one processor is configured to:
determine whether each of the set of signal strength values satisfies at least one threshold, wherein each of the set of spatial domain filters is determined further based on whether the respective signal strength value satisfies the at least one threshold, and wherein the RACH configuration indicates the at least one threshold.

10. The first network node of claim 9, wherein to transmit, to the second network node, a plurality of preamble messages using the set of spatial domain filters based on the RACH configuration, the at least one processor is configured to:
transmit the plurality of preamble messages respectively using the set of spatial domain filters based on a set of indices with which the set of spatial domain filters is respectively configured when a number of the set of signal strength values that satisfy the at least one threshold is less than a number of configured spatial domain filters.

11. The first network node of claim 1, wherein the plurality of preamble messages comprises one of a same preamble or at least two different preambles.

12. The first network node of claim 11, wherein the RACH configuration indicates whether the plurality of preamble messages is to include the same preamble or the at least two different preambles.

13. The first network node of claim 1, wherein at least two of the plurality of preamble messages are multiplexed in at least one of time or frequency.

14. The first network node of claim 1, wherein the plurality of preamble messages includes at least one of:
one or more instances of a first preamble message; or
one or more instances of a second preamble message.

15. The first network node of claim 1, wherein, to transmit the plurality of preamble messages using the set of spatial domain filters based on the RACH configuration, the at least one processor is configured to:
transmit one or more instances of a first preamble message using a first spatial domain filter of the set of spatial domain filters based on the RACH configuration.

16. The first network node of claim 15, wherein, to transmit the plurality of preamble messages using the set of spatial domain filters based on the RACH configuration, the at least one processor is configured to:
transmit one or more instances of the first preamble message using a second spatial domain filter of the set of spatial domain filters based on the RACH configuration.

17. The first network node of claim 15, wherein, to transmit the plurality of preamble messages using the set of spatial domain filters based on the RACH configuration, the at least one processor is configured to:
transmit one or more instances of a second preamble message using a second spatial domain filter of the set of spatial domain filters based on the RACH configuration.

18. A first network node, comprising:
a memory; and
at least one processor coupled to the memory, wherein the at least one processor is configured to:
transmit each of a set of reference signals via a respective beam of a set of beams,
transmit a random access channel (RACH) configuration associated with spatial domain filtering for transmission of a plurality of preamble messages of a RACH procedure, and
perform the RACH procedure, wherein, to perform the RACH procedure, the at least one processor is configured to:
receive, from a second network node, at least one of the plurality of preamble messages associated with at least one of a set of spatial domain filters that corresponds to at least one set of the set of beams.

19. The first network node of claim 18, wherein the RACH configuration indicates at least one of a number of the plurality of preamble messages or a number of the set of spatial domain filters.

20. The first network node of claim 18, wherein, to transmit the RACH configuration, the at least one processor is configured to:
transmit the RACH configuration via one of a system information block (SIB) or radio resource control (RRC) signaling.

21. The first network node of claim 18, wherein the set of reference signals comprises at least one of a synchronization signal block (SSB) or a channel state information reference signal (CSI-RS).

22. The first network node of claim 21, wherein a first subset of the set of reference signals comprises a set of SSBs and a second subset of the set of reference signals comprises a set of CSI-RSs.

23. The first network node of claim 18, wherein the plurality of preamble messages comprises one of a same preamble or at least two different preambles.

24. The first network node of claim 23, wherein the RACH configuration indicates whether the plurality of preamble messages is to include the same preamble or the at least two different preambles.

25. The first network node of claim 18, wherein, to receive, from the second network node, the at least one of the plurality of preamble messages associated with the at least one of the set of spatial domain filters that corresponds to the at least one set of the set of beams, the at least one processor is configured to:
receive at least two of the plurality of preamble messages that are multiplexed in at least one of time or frequency.

26. The first network node of claim 18, wherein the at least one of the plurality of preamble messages includes at least one of:
one or more instances of a first preamble message; or
one or more instances of a second preamble message.

27. The first network node of claim 18, wherein, to receive, from the second network node, the at least one of the plurality of preamble messages associated with the at least one of the set of spatial domain filters that corresponds to the at least one set of the set of beams, the at least one processor is configured to:
receive one or more instances of a first preamble message associated with a first spatial domain filter of the set of spatial domain filters based on the RACH configuration.

28. The first network node of claim 27, wherein, to receive, from the second network node, the at least one of the plurality of preamble messages associated with the at least one of the set of spatial domain filters that corresponds to the at least one set of the set of beams, the at least one processor is configured to:
receive one or more instances of the first preamble message associated with a second spatial domain filter of the set of spatial domain filters based on the RACH configuration.

29. The first network node of claim 27, wherein, to receive, from the second network node, the at least one of the plurality of preamble messages associated with the at least one of the set of spatial domain filters that corresponds to the at least one set of the set of beams, the at least one processor is configured to:
receive one or more instances of a second preamble message associated with a second spatial domain filter of the set of spatial domain filters based on the RACH configuration.

30. The first network node of claim 18, wherein the RACH configuration indicates at least one threshold associated with the set of reference signals respectively corresponding to the at least one of the set of spatial domain filters.
